(19) United States
(12) Patent Application Publication
(10) Pub. No.: US 2024/0346349 A1
(43) Pub. Date: Oct. 17, 2024

(54) Lagrangian Method for Efficient Computation of First-Order Derivative Properties of Observables of Quantum States Representing Fermions in Quantum Computers

(71) Applicants: QC WARE CORP., Palo Alto, CA (US); COVESTRO DEUTSCHLAND AG, Leverkusen (DE)

(72) Inventors: Robert Michael PARRISH, Woodside, CA (US); Christian Gogolin, Köln (DE)

(21) Appl. No.: 18/276,638

(22) PCT Filed: Feb. 15, 2022
(86) PCT No.: PCT/US2022/016442

§ 371 Date: Aug. 9, 2023

Related U.S. Application Data
(60) Provisional application No. 63/237,504, filed on Aug. 26, 2021.
(60) Provisional application No. 63/150,018, filed on Feb. 16, 2021.

(51) Int. Cl. G06N 10/20; G06F 17/11; G06N 10/60

(52) U.S. Cl. CPC G06N 10/20; G06F 17/11; G06N 10/60

(57) ABSTRACT

The present disclosure provides methods for computing first-order derivative properties of observables of fermionic systems, such as the derivatives of electronic ground and exited states of molecules and materials with respect to the positions of the nuclei, with the help of a quantum computer. The method has the advantageous property that first-order derivative properties with respect to an arbitrary number of parameters of the fermionic system can be computed with a quantum computational effort that is independent of the number of such parameters. First-order derivatives of additional observables, such as wave function overlaps, multipole moments, and electronic density characteristics with respect to additional derivative perturbations, such as nuclear charges and electromagnetic fields, can be evaluated within the same framework, with additional applications such as computation of non-adiabatic dynamics, (hyper)polarizabilities, electrical conductivities, and various spectroscopies of the molecular or material system in question.

### CROSS-REFERENCE TO RELATED APPLICATIONS

This application claims priority to U.S. Provisional Patent Application No. 63/150,018 “Lagrangian Method for Efficient Computation of First-Order Derivative Properties of Observables of Quantum States Representing Fermions in Quantum Computers,” filed on Feb. 16, 2021 and priority to U.S. Provisional Patent Application No. 63/237,504, “Lagrangian Method for Efficient Computation of First-Order Derivative Properties of Observables of Quantum States Representing Fermions in Quantum Computers,” filed on Aug. 26, 2021, each of which is hereby incorporated by reference in its entirety.

### BACKGROUND

### 1. Technical Field

This disclosure relates generally to computing first-order derivative properties of observables of fermionic systems.

### 2. Description of Related Art

Numerous computational methods have been proposed to simulate the wave functions of fermionic systems with the assistance of a quantum computer. Such methods include quantum phase estimation (QPE), the variational quantum eigensolver (VQE), and extensions to VQE, such as the multistate contracted VQE (MC-VQE), subspace search VQE (SS-VQE) or quantum subspace expansion (QSE-VQE), and externally contracted methods, such as quantum filter diagonalization (QFD), nonorthogonal VQE (NO-VQE), and multireference selected quantum Krylov (MRSQK). Such methods are designed to evaluate scalar observable quantities depending on fermionic wave functions, such as the energy of a single ground- or excited-state fermionic wavefunction.

An extension to such methods is the development of an approach to additionally evaluate first-order derivatives of observables with respect to arbitrary parameters of the fermionic system. An example is the “nuclear gradient,” defined as the derivative of the energy of a wavefunction of the electrons of a molecule or material system with respect to the positions of the nuclei in the molecule or material. The ability to efficiently compute such first-order derivative properties may be important for the solution of many technically relevant problems with such simulation techniques.

During the simulation of the wave function of the fermionic system, one encounters intermediate computational parameters whose continuous values are determined by solving nonlinear equations depending on observable quantities of the wave functions and the system parameters. These intermediate computational parameters may be determined by either or both classical computing or quantum computing elements of the method. For instance, on the classical side, one can use methods such as Hartree-Fock to determine the parameters of a set of 1-particle orbitals of the fermionic system. For another instance, on the quantum side, one can use methods such as VQE or MC-VQE to determine the parameters of the quantum circuit representations of the wave functions. The finished scalar observable quantities of the wave functions produced by such methods will usually depend on the values of the intermediate computational parameters. When the total derivative of a wave function observable quantity is evaluated with respect to a system parameter, there typically arise nonzero “wavefunction response” contributions stemming from the variations of the intermediate computational parameters with variations in the system parameter. These wavefunction response contributions must be included to compute a numerically valid derivative. Thus, with conventional methods for computing derivative properties, the cost of evaluating first-order derivatives of a given scalar observable quantity costs significantly more than evaluating the scalar observable quantity itself, especially if many derivative perturbations are targeted, due to the cost of computing the wavefunction response contribution separately for each derivative perturbation. E.g., for the nuclear gradient, the wavefunction response will have to be computed for each of the O(3Nₐₜₒₘ) derivative perturbations of the Cartesian positions of the atoms compared to the O(1) computations needed for the scalar wave function energy

In purely classical electronic structure methods, the lossless reduction of the cost of evaluating the wavefunction response contributions from O(N_{deriv}) to O(1) has been the topic of extensive study over several decades. The reduction has been realized independently in a variety of contexts, and has been called such names as the “Delgarno-Stewart Interchange Theorem,” the “Knowles-Handy Z-Vector Trick” and the “Helgaker Lagrangian Formalism.” We will refer to the reduction as the “Lagrangian formalism” throughout. The general idea is to interchange the order of partial derivatives applied in the chain rule terms contributing to the total derivative to produce a single collective wavefunction response intermediate that does not directly depend on the derivative perturbation. Perhaps the simplest way to view this is to construct a Lagrangian scalar quantity equal to the target scalar observable everywhere in the parameter space, but additional containing additive zero quantities defined as Lagrange multipliers multiplied with the zero-based first-order stationary forms of the nonlinear equations used to determine the intermediate computational parameters of the method. The initial solving of the nonlinear equations to determine the intermediate computational parameters during wavefunction construction makes the Lagrangian stationary with respect to the Lagrange multipliers. Additionally, requiring that the Lagrangian be stationary with respect to the intermediate system parameters yields a single set of linear equations that determines the Lagrange multipliers. This set of linear wavefunction response equations can be solved once for a given observable quantity, and often exhibits exact decoupling into blocks for different classes of intermediate parameters. Finally, the total derivative of the observable quantity can be evaluated with respect to an arbitrary parameter of the system as the partial derivative of the Lagrangian with respect to that parameter. Notably, the response terms are computed separately from the derivative perturbations in this formalism. The adaption of Lagrangian formalism to quantum computing methods for fermionic systems that constitutes the focus of this disclosure has not yet been realized in the prior art, and is the focus of the present disclosure. Prior to this disclosure, the major barrier to the adaption of the Lagrangian formalism to quantum computing methods for fermionic systems was that it was not obvious how to adapt the Lagrangian approach from classical computing methods where one has explicit computational access to the fermionic wavefunction quantities to the quantum computing methods where one only has access to observable quantities involving the representations of the fermionic systems within the involved quantum circuits.

### SUMMARY

The present disclosure provides methods for computing first-order derivative properties of observables of fermionic systems, such as the derivatives of electronic ground and exited states of molecules and materials with respect to the positions of the nuclei, with the help of a quantum computer. The methods have the advantageous property that first-order derivative properties with respect to an arbitrary number of parameters of the fermionic system can be computed with a quantum computational effort that is independent of the number of such parameters. Nuclear gradients computed in this way may, e.g., subsequently be used to optimize the nuclear geometry of a molecule (i.e., to find the nuclear geometry with lowest energy), to predict characteristics (e.g., reaction energies or reaction rates) or direct dynamics of chemical reactions, to compute the vibrational frequencies of the fermionic system, and for other applications. First-order derivatives of additional observables, such as wave function overlaps, multipole moments, and electronic density characteristics with respect to additional derivative perturbations, such as nuclear charges and electromagnetic fields, can be evaluated within the same framework, with additional applications such as computation of non-adiabatic dynamics, (hyper)polarizabilities, electrical conductivities, and various spectroscopies of the molecular or material system in question.

Other aspects include components, devices, systems, improvements, methods, processes, applications, computer readable mediums (e.g., non-transitory computer readable storage mediums), and other technologies related to any of the above.

### BRIEF DESCRIPTION OF THE DRAWINGS

Embodiments of the disclosure have other advantages and features which will be more readily apparent from the following detailed description and the appended claims, when taken in conjunction with the example in the accompanying drawing, in which:

FIGS. 1A-1C illustrate an example method for the case where wave functions of a fermionic system are represented by FOMO-RHF-MC-VQE (FOMO-RHF orbitals followed by an MC-VQE active space wave computation that may be performed on a quantum computer) and for the example case where a derivative to be computed is the derivative of the energy of the system with respect to the positions of the nuclei.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of this disclosure.

One object of the disclosure is a method for computing first-order derivatives of observable quantities of fermionic wave functions represented in part by state vector quantities prepared by one or more parametrized quantum circuits in one or more quantum computers. The method has the following desirable properties: (1) the method is applicable to cases where fermionic systems are simulated by hybrid classical/quantum computational methods; and (2) the number of quantum and classical response equations to be solved is formally independent of the number of first order derivatives. This is beneficial as the number of first order derivatives in practical applications is often high, particularly when computing, for example, the 3N components of the nuclear gradient of a chemical system with N nuclei. The method further has the desirable property that the quantum and classical response terms are separated whenever formally allowed, with mixed quantum/classical response terms occurring only in formally unavoidable cases.

Accordingly, a method for computing, given a fermionic system depending on one or more continuous system parameters and having a wave function and a set of one or more observables, first-order derivatives of one or more of the observables of the fermionic system, with the assistance of a quantum computer, the quantum computer being configured to execute one or more quantum circuits, the quantum circuits depending on one or more continuous quantum circuit parameters is provided.

The method may comprise:
defining a Lagrangian for each of the one or more observables to be differentiated as the formal definition of that observable;
defining a representation of the wave functions of the fermionic system depending on one or more continuous intermediate computational parameters, with at least one of these parameters being one of the continuous quantum circuit parameters;
modifying the one or more continuous intermediate computational parameters of the wave function of the fermionic system to make one or more continuous nonlinear equations equal to zero, the one or more continuous nonlinear equations including at least one observable of the fermionic system that is determined, at least in part, by the quantum computer executing a quantum circuit;
adding to the Lagrangian, for each of the nonlinear equations, a product of the nonlinear equation times a Lagrange multiplier;
determining the Lagrange multipliers for each set of nonlinear equations to make the part of the Lagrangian corresponding these nonlinear equations stationary with respect to their respective intermediate computational parameters, the determination of the Lagrange multipliers involving at least one observable that was determined, at least in part, by the quantum computer, the cost of determining the Lagrange multipliers depending on the number of intermediate computational parameters but not on the number of system parameters with respect to which the first-order derivatives are to be computed;
obtaining at least one first-order derivative of an observable of the fermionic system with respect to any subset of system parameters by determining the partial derivatives of the Lagrangian with respect to these system parameters.

Classically computing a quantity means computing without the help of a quantum computer. In the same vein, classically representing, or classically contracting, means representing or contracting without the help of a quantum computer.

A fermionic system means any system comprising fermionic particles. Particles can be both physical particles as well as quasiparticles that emerge as collective excitations of an underlying physical system. Examples of fermionic particles are electrons, protons and neutrons, odd spin nuclear cores, as well as fractional quantum Hall composite fermions and Skyrmions.

A chemical system is any physical system or model thereof comprising electrons.

An orbital may be a wavefunction representing the quantum state of a single fermion. In many cases, an orbital may be represented as a product of a spatial wavefunction component (a spatial orbital) and a spin wavefunction component (e.g., an alpha or beta spin wavefunction component). In such cases, the product of the spatial orbital and spin component is referred to as a spin orbital.

The quantum states of multi-particle fermionic systems may be represented by the Fock space approach, wherein a discrete set of spin orbitals are defined, and the wavefunctions of the fermionic system are defined as a linear combination of the discrete set of antisymmetrized products of occupied subsets of these spin orbitals (Slater determinants). The wave function of the electrons of a chemical system is also referred to as the electronic wave function of that system.

The set of spin orbitals used in the definition of a Fock space is referred to as an orbital basis.

If the spatial orbital components are chosen to be the same for the alpha and beta spin orbitals, the Fock space approach is referred to as spin restricted.

For many common fermionic systems, multi-particle quantum wavefunctions of interest will typically have definite values for quantum numbers, such as the alpha-number (number of spin up electrons), beta-number (number of spin down electrons), and total spin-squared number, with the formal definition of having a definite value for one of the quantum numbers being the property of that the wavefunction is an eigenstate of the corresponding number operator with given eigenvalue.

The subspace of a Fock space corresponding to a definite alpha-number, beta-number, and spin-squared number value (or subsets of these number values) is referred to as a “subset,” “sector,” “irreducible representation”, or “irrep” of the Fock space.

A Fock space defined in terms of a complete single-fermion spin orbital basis without other restrictions will definitionally be a complete Fock space, i.e., a Fock space that is capable of representing an arbitrary multi-particle fermionic quantum state over the orbitals.

An active space Fock space method may be defined as an approximate Fock space method where the orbital basis is partitioned into disjoint closed, active, and virtual subsets (some of which may be empty). The occupation numbers of the closed orbitals are constrained to be one (fully occupied), the occupation numbers of the virtual orbitals are constrained to be zero (fully unoccupied), and the occupation numbers of the active orbitals are unconstrained.

The quantum state of a quantum computer may be represented as a state vector in a Hilbert space, defined as a linear inner product space over all possible configurations of the quantum register of the quantum computer.

In many cases, the active space of a Fock space of a multi-particle fermionic system can be mapped to the Hilbert space of a quantum computer by means of an isomorphic embedding.

Observable quantity means any quantity that is in principle measurable or otherwise characteristic for the behavior of a physical system. Examples of observable quantities of fermionic systems include: the energy, the Spin, the position of an atom, the charge distribution, as well as any quantum mechanical observable associated with a the expectation value of a Hermitian operator or positive operator valued measurement, or any quantity that is a function of other observable quantities. Observable quantities may be computable by means of a computation that may be carried out with or without the help of a quantum computer. Determining an observable quantity (at least in part) by means of a quantum computer means that at least one quantity influencing the value of the observable quantity was computed using a quantum computer.

A quantum computer is a device exploiting quantum effects of some of its constituents for information processing. The set of constituents to which quantum operations are applied during a computation is called the quantum register. Quantum computers can be realized with a broad range of approaches, including but not limited to: superconducting qubits, trapped ions, trapped atoms, photons, quantum dots, nitrogen vacancy centers in diamond, spin qubits in silicon, nuclear magnetic resonance, or topological quantum computing. The program executed by a quantum computer is called a quantum circuit. The result of the computation of a quantum computer comprises the results of one or more measurements of the constituents exhibiting quantum effects.

System parameters are parameters characterizing an associated system. Examples of system parameters include: the number and types of particles, positions of nuclear coordinates, strengths and directions of external fields.

Quantum circuits are lists of instructions specifying how a quantum computer should carry out a certain quantum algorithm. Quantum circuits can contain instructions that specify that certain (e.g., elementary) quantum and/or classical logic operations, so called gates, are to be applied to certain constituents of the quantum computer in a certain order. Some gates depend on a continuous parameter, examples being the Pauli X, Y, and Z rotation gates. We refer to the union of all such parameters in a quantum circuit as the circuit parameters.

Quantities that represent neither system parameters nor observables and whose values are not immediately and uniquely determined by the system parameters are intermediate computational parameters. Examples of intermediate computational parameters may be quantum circuit parameters and orbital parameters whose values are determined during the computation.

By modifying the values of circuit parameters the operations performed by the quantum computer when applying the instructions in the quantum circuit as well as the result of the computation may be changed. Of some quantity, such as the value of an observable quantity is, at least in part, determined by means of a quantum computer, then modifying the circuit parameters can change the value computed for that observable quantity. An example for how an observable quantity can depend on the circuit parameters is an observable quantity of the fermionic system that is determined as a weighted sum of expectation values of quantum mechanical observables of some of the constituents of the quantum computer in a state prepared inside the quantum computer by means of a parametrized circuit.

A mapping from one Hilbert space to another (whereby both spaces can be subspaces of larger Hilbert spaces) is a isomorphic embedding of the first Hilbert space to the second, and it may imply a natural mapping of the states of and the operators on the first Hilbert space to those of the second.

One step of the method may include defining a Lagrangian for each of the one or more observables to be differentiated as the formal definition of that observable.

A Lagrangian is a scalar function that is equal in value to an observable quantity for all possible values of the system parameters, but with additional Lagrange multiplier terms (each equal to zero) added. The Lagrangian is said to be stationary with respect to a set of its parameters, such as the intermediate computational parameters or the Lagrange multipliers, when its first total derivative with respect to these parameters is equal to zero. Making the Lagrangian stationary with respect to a set of parameters means determining values for intermediate computational parameters and Lagrange multipliers such that it is stationary with respect to these parameters. A detailed mathematical definition of the Lagrangian formalism is provided in Section III.D of the Example below.

The algebraic difference between the observable and the Lagrangian is a sum of terms defined as Lagrange multiplier parameters multiplied by continuous nonlinear equations in zero form defining the conditions or constraints for continuous intermediate computational parameters of the observable.

Another step of the method may include defining a representation of the wave functions of the fermionic system depending on one or more continuous intermediate computational parameters, with at least one of these parameters being one of the continuous quantum circuit parameters. Examples include defining the functional representation of the wavefunction in terms of the intermediate computational parameters, defining one or more nonlinear equations including at least one observable quantity of the fermionic system that must be zero to determine the values of the continuous intermediate computational parameters, and then determining the values of the intermediate computational parameters by solving these nonlinear equations.

Examples for continuous nonlinear equations including at least one observable quantity of the fermionic system include the derivative of the energy (expectation value of the Hamiltonian) with respect to any number of continuous intermediate parameters being equal to zero (stationarity in wavefunction energy), the derivative of the energy over an auxiliary wavefunction with respect to any number of continuous intermediate parameters being equal to zero (stationarity in energy of an auxiliary wavefunction method), the derivative of the weighted average of energies over several primary or auxiliary wavefunctions with respect to any number of continuous intermediate parameters being equal to zero (stationarity in state-averaged energy), spatial orbitals being orthonormal in overlap (part of a fractionally-occupied molecular orbital restricted Hartree-Fock (FOMO-RHF) method), occupation numbers of orbitals being equal to Fermi-Dirac or similar sigmoid function values depending on orbital energies (part of FOMO-RHF), the sum of occupation numbers of orbitals being equal to a user-specified number of electrons (part of FOMO-RHF), the expectation values of the Fock operator over pairs of spatial orbitals being diagonal (part of FOMO-RHF), among myriad other possible choices.

A further step in the method may include modifying the one or more continuous intermediate computational parameters of the wave function of the fermionic system to make one or more continuous nonlinear equations equal to zero, the one or more continuous nonlinear equations including at least one observable of the fermionic system that is determined, at least in part, by the quantum computer executing a quantum circuit. The parameters are thereby typically modified by means of a optimization procedure whose cost function is a non-linear equation including one or more of the system parameters. Determining an observable, at least in part, by a quantum computer may be done by preparing constituents of the quantum computer in a quantum state and then having the quantum computer perform measurements on that state with the aim of estimating the expectation values of one or more quantum mechanical observables of the constituents of the quantum computer, which, by the nature of the prepared state, the mapping, and the quantum computation performed can be linearly combined to yield an estimate of the observable of the fermionic system.

A further step in the method may include adding to the Lagrangian, for each of the nonlinear equations, a product of the nonlinear equation times a Lagrange multiplier.

A further step in the method may include determining the Lagrange multipliers for each set of nonlinear equations to make the part of the Lagrangian corresponding these nonlinear equations stationary with respect to their respective intermediate computational parameters, the determination of the Lagrange multipliers involving at least one observable that was determined, at least in part, by the quantum computer, the cost of determining the Lagrange multipliers depending on the number of intermediate computational parameters but not on the number of system parameters with respect to which the first-order derivatives are to be computed.

A Lagrangian may be made stationary with respect to all Lagrange multipliers by solving the continuous nonlinear equations in zero form for all Lagrange multipliers, thereby determining the value of the intermediate computational parameters. At this point, the representation of the wave functions of the fermionic system and the corresponding observable quantities may be completed. However, the Lagrangian is not yet stationary with respect to the intermediate computational parameters, and the values of the Lagrange multipliers have not yet been determined.

The Lagrange multiplier parameters can be determined by making the Lagrangian stationary with respect to all intermediate computational parameters. Due to the algebraic structure of the Lagrangian, where the Lagrange multipliers appear only as linear products with the continuous nonlinear equations in zero form, the determination of the Lagrange multiplier parameters can be always accomplished by the solution of a set of linear equations involving the product of the matrix of derivatives of the continuous nonlinear equations with respect to intermediate computational parameters multiplied by the vector of unknown Lagrange multipliers, which may be set to be equal to the vector of derivatives of the observable quantity with respect to intermediate computational parameters. These linear equations are referred to as the “linear response equations.”

A further step in the method may include obtaining at least one first-order derivative of an observable of the fermionic system with respect to any subset of system parameters by determining the partial derivatives of the Lagrangian with respect to these system parameters thereby having obtained the one or more sought after first order derivatives while soling a number of response equations that is independent of the number of first order derivatives.

In some embodiments of the method, the fermionic system further has orbitals, the orbitals being defined in terms of an orbital basis, the orbital basis depending in a differentiable way on one or more system parameters and on one or more orbital parameters, and the wave function of the fermionic system being defined with respect to a Hilbert space over these orbitals, and wherein the continuous intermediate computational parameters include the orbital parameters and wherein modifying the one or more continuous intermediate computational parameters of the wave function of the fermionic system comprises modifying one or more of the orbital parameters to make one or more nonlinear equations equal to zero, the one or more nonlinear equations including observable quantities of the fermionic system.

In some embodiments, preferably the Hilbert space is the fermionic Fock space over the orbitals and is divided into a closed subspace, an active subspace, and a virtual subspace, whereby the subspaces are nonoverlapping spaces and the closed space and/or virtual space may be empty, and the wave function is restricted to be fully occupied inside the closed space and unoccupied in the virtual space.

In some embodiments, it is further preferred that the method comprises:
choosing a mapping between the active space and a subspace of the Hilbert space of the quantum computer, whereby the subspace can be the full Hilbert space of the quantum computer;
determining values of one or more of the observable quantities with the assistance of a quantum computer performing quantum computations involving the preparation of one or more quantum states in the quantum computer corresponding to wave functions of the fermionic system under the chosen mapping by means of quantum circuits, the quantum circuits having one or more continuous circuit parameters;
modifying one or more circuit parameters to make one or more nonlinear equations involving the observable quantities equal to zero; and
adding to the Lagrangian, for each of the nonlinear equations, a product of the nonlinear equation times a Lagrange multiplier.

In some embodiments, it is further preferred that determining the Lagrange multipliers that make the Lagrangian stationary comprises:
determining the Lagrange multipliers for the circuit parameters by solving quantum linear response equations to make the part of the Lagrangian corresponding to the quantum circuit parameters stationary with respect to the quantum circuit parameters, the quantum linear response equations including quantities that were determined with the assistance of the quantum computer; and
determining the Lagrange multipliers for the orbital parameters by solving orbital linear response equations to make the part of the Lagrangian corresponding to the orbital parameters stationary with respect to the orbital parameters, the orbital linear response equations including quantities that were determined with the assistance of the quantum computer.

In some embodiments of the method, the steps used in the determination of the orbital parameters and/or the determination of the quantum circuit parameters are modified to use quantum and/or classical computation, including coupling between the selection of the orbital and quantum circuit parameters, with corresponding changes in the structure of the Lagrangian and the structure of the resulting wavefunction response equations without altering the property that the number of response equations is independent of the number or type of derivative perturbations.

In some embodiments of the method, the orbitals are constructed and modified by means of a FOMO-RHF procedure. This may provide better orbital parameters than a standard RHF procedure (which is included as the special case of the FOMO-RHF with a vanishing FOMO temperature) and thereby yield a more accurate first order derivative properties even when the active space is comparably small. This may allow for the simulation of large chemical systems with fewer qubits.

In some embodiments of the method, the representation of the quantum circuit parameters are chosen and modified by means of an MC-VQE procedure. This has the advantage that the method can then be used to compute first order derivatives of ground and excited states, keeping the advantageous property that the number of response equations that need to be solved is independent of the number of first order derivatives that are to be computed.

In some embodiments of the method, modifying the one or more continuous intermediate computational parameters comprises modifying orbital parameters and quantum circuit parameters in a way that makes one or more non-linear equation involving both orbital parameters and quantum circuit parameters equal to zero. In such embodiments of the method, a simultaneous optimization of both the orbital parameters and the circuit parameters can be modified at the same time. This can improve the overall precision of the obtained first order derivative properties.

In some embodiments of the method, modifying the one or more continuous intermediate computational parameters comprises modifying one or more matrix elements of the second-quantized fermionic Hamiltonian. In this embodiment, the Lagrangian formalism may produce linear response equations that cause the Lagrangian to be stationary with respect to the matrix elements, obviating the need for the explicit response of each matrix element to be evaluated for each derivative perturbation.

In some embodiments of the method, modifying the one or more continuous intermediate computational parameters comprises modifying one or more tensor elements of the second-quantized fermionic Hamiltonian expressed or approximated by a tensor factorization techniques such as, but not limited to, density fitting, Cholesky decomposition, eigendecomposition, double factorization, or tensor hypercontraction. In this case, the Lagrangian formalism may produce a nested set of response equations that cause the Lagrangian to be stationary first with respect to the tensor-factorized approximate matrix element, and from thence with respect to the underlying unconstrained parameters of the tensor factorization method, obviating the need for the explicit response of each approximate matrix element or underlying unconstrained parameter to be evaluated for each derivative perturbation.

In some embodiments of the method, the fermionic system describes electrons of a chemical system comprising at least one of: a molecule, an atom, a charge, an electron, or an anti-particle.

In some embodiments of the method, the observable quantity to be differentiated is the energy of a wavefunction, the overlap between two wavefunctions with zero or more of the wavefunctions defined to be frozen under the action of the derivative operator, or a multipole moment or other characteristic of the fermionic density corresponding to a wavefunction.

In some embodiments of the method, the derivatives are calculated with respect to positions and/or magnitudes of external charges, electric fields, or magnetic fields of or acting on the fermionic system. The computation of first order derivatives of the energy with respect to positions of the electric charges of the nuclei may be important for practical applications of the method, for example for the identification of transition states of chemical systems which are crucial determining properties such as chemical reaction rates.

In some embodiments, the method further comprises steps to perform a simulation of a chemical reaction or properties of such chemical reaction.

In some embodiments, the method is a computer-implemented method.

The present disclosure also relates to a data processing apparatus system comprising means for carrying out any of the methods according to the disclosure.

In some embodiments, the method further comprises: transmitting and/or receiving a description of the fermionic system, the observables, the active space, the representations of the observables on the active space, the quantum circuits preparing the states in the quantum computer corresponding to the wave functions of the fermionic system, and/or the resulting first order derivatives to/from the quantum computer or a data processing apparatus system according to the disclosure.

In some embodiments, the apparatus comprises a quantum computer realized with one of the following approaches: superconducting qubits, trapped ions, trapped atoms, photons, quantum dots, nitrogen vacancy centers in diamond, spin qubits in silicon, nuclear magnetic resonance, or topological quantum computing.

In some embodiments, the determination of the Lagrange multipliers that make the Lagrangian stationary comprises solving one or more equations with exact, approximate and/or iterative algebraic solvers.

The present disclosure also relates to a computer program product comprising instructions which, when the program is executed by a computer, cause the computer to carry out any of the methods of the disclosure.

Furthermore, the present disclosure also relates to a computer-readable storage medium comprising instructions which, when executed by a computer, cause the computer to carry out any of the methods of the disclosure.

A first exemplary, non-limiting procedure for a specific embodiment of the method as described herein is given in the following section. Here the parameters of the orbitals are chosen by a classical method and the parameters of the quantum circuits are chosen by a hybrid quantum/classical method in an active space of these orbitals:

The method for the determination of first-order derivative properties of observable quantities of fermionic wavefunctions relates to the case where the 1-particle orbital parameters are determined in one step by a classical method and then the fermionic wavefunctions are subsequently determined in a second step in an active space of these orbitals by a hybrid quantum/classical method.

A feature of this embodiment is the separation of the classical (determination of the orbital parameters) and quantum (determination of the parameters defining the wave function in the active space) steps that precludes iterative feedback between the classical and quantum portions of the method. The steps of this method may comprise:
A. Computing a differentiable representation of the molecular orbitals of the system from the classically tractable overlap and potential matrix elements of the molecular system.
B. Dividing the molecular orbitals into nonoverlapping closed (doubly-occupied), active (fractionally-occupied), and virtual (unoccupied) subsets.
C. Translating the fermionic electronic Hamiltonian and other desired observables in the active space into an equivalent qubit representation in terms of a polynomial-scaling linear combination of Pauli terms.
D. Approximating the ground- and excited-state electronic wavefunctions within the active space via a quantum ansatz involving parametrized quantum circuits preparing quantum wave functions. These approximations may require an exponential-scaling amount of effort to represent classically, but may only require a polynomial-scaling amount of effort with access to a quantum computer.
E. Extracting the polynomial-scaling and classically-representable one- and two-particle diagonal and transition density matrix elements of the ground- and excited-state adiabatic electronic wavefunctions within the active space as a set of expectation values evaluated over the Pauli strings of the qubit-basis Hamiltonian.
F. Computing the energies and other observables of the ground- and excited-state adiabatic electronic wavefunctions by contracting (i.e., summing over products of matching scalar components of the respective tensors) the one- and two-particle diagonal and transition density matrix elements with the corresponding Pauli-basis observable matrix elements.
G. For each observable to be differentiated, defining a Lagrangian for the specification of the quantum steps taken in Step D to compute one or more input parameters of the wavefunction.
H. For each observable to be differentiated, for any quantum elements of the Lagrangian in Step G, solving the appropriate first-order quantum response equations to make the Lagrangian stationary with respect to the non-variational quantum circuit parameters of the method.
I. For each observable to be differentiated, evaluating the total derivative of the observable with respect to the Pauli-basis observable matrix elements. Due to the nature of the Lagrangian formalism, this may be equivalent to the partial derivative of the Lagrangian with respect to the Pauli-basis observable matrix elements. This quantity may be referred to as the “relaxed density matrix in Pauli form,” may be classically computable from the output of a quantum computer, may be strictly independent of the number of forthcoming derivative perturbations, and may be strictly independent of the response contributions from the classical orbital determination step.
J. For each observable to be differentiated, classically transforming the relaxed active space density matrix from the Pauli-basis representation to the standard second-quantized representation through linear contractions.
K. For each observable to be differentiated, defining a complete Lagrangian for the specification of the classical steps taken in Step A to compute one or more intermediate parameters of the wavefunction. Determine and store this Lagrangian in terms of the classically-representable relaxed density matrix in the active space produced from Step J.
L. For each observable to be differentiated, for any classical elements of the Lagrangian in Step A, solving the appropriate first-order classical response equations to make the Lagrangian stationary with respect to the non-variational classical parameters of the method.
M. For each observable to be differentiated, evaluating the total derivative of the observable with respect to the classical overlap and potential matrix elements. Due to the nature of the Lagrangian formalism, this may be equivalent to the partial derivative of the Lagrangian with classical overlap and potential matrix elements. This quantity may be referred to as the “relaxed classical density matrix,” may be classically representable, and may be strictly independent of the number of forthcoming derivative perturbations.
N. Contracting the relaxed classical density matrix with the classical derivatives of the classical overlap and potential matrix elements, for each derivative perturbation. Note that this may be the only stage of the computation where the derivative perturbations are encountered, i.e., the quantities and computational costs (both quantum and classical) in the previous sections are all wholly independent of the number of derivative parameters.

A second exemplary, non-limiting procedure describes a further specific embodiment where the orbitals are chosen by the fractionally-occupied molecular orbital restricted Hartree-Fock (FOMO-RHF) method and where the wave functions of the fermions are determined by the hybrid quantum/classical multistate, contracted variational quantum eigensolver (MC-VQE) method applied within an active space.

In this embodiment, the orbital parameters are classically chosen by fractional occupation molecular orbital restricted Hartree Fock (FOMO-RHF) and the fermionic wavefunctions are subsequently determined in a second step in an active space of these orbitals by the hybrid quantum/classical multistate contracted variational quantum eigensolver (MC-VQE) method. The steps of this method may comprise:
A. Classically computing a differentiable representation of the molecular orbitals of the system from the classically tractable overlap and potential matrix elements of the molecular system by solving the FOMO-RHF equations.
B. Dividing the molecular orbitals into nonoverlapping closed (doubly-occupied, classical), active (fractionally-occupied, quantum), and virtual (unoccupied, classical) subsets.
C. Translating the fermionic electronic Hamiltonian and other desired observable operators in the active space into an equivalent qubit representation in terms of a polynomial-scaling linear combination of Pauli terms.
D. Approximating the ground- and excited-state adiabatic electronic wavefunctions within the active space via the quantum ansatz of the MC-VQE method involving parametrized quantum circuits preparing quantum wave functions. These approximations may require an exponential-scaling amount of effort to represent classically, but may only require a polynomial-scaling amount of effort with access to quantum hardware devices.
E. Extracting the polynomial-scaling and classically-representable one- and two-particle diagonal and transition density matrix elements of the ground- and excited-state adiabatic electronic wavefunctions within the active space as a set of expectation values evaluated over the Pauli strings of the qubit-basis Hamiltonian.
F. Computing the energies and other observables of the ground- and excited-state adiabatic electronic wavefunctions by classically linearly contracting the appropriate elements of the one- and two-particle diagonal and transition density matrix elements with the corresponding Pauli-basis observable matrix elements.
G. For each observable to be differentiated, determining a complete Lagrangian for the specification of the quantum steps taken in the MC-VQE procedure (Step D) to compute one or more input parameters of the wavefunction (e.g., any non-variational problem-specific continuous input parameters of the wavefunction, such as the state-averaged VQE (SA-VQE) quantum circuit parameters).
H. For each observable to be differentiated, for any quantum elements of the Lagrangian in Step G, solving the appropriate first-order quantum response equations to make the Lagrangian stationary with respect to the non-variational quantum circuit parameters of the method, e.g., by solving the SA-VQE response equations.
I. For each observable to be differentiated, evaluating the total derivative of the observable with respect to the Pauli-basis observable matrix elements. Due to the nature of the Lagrangian formalism, this may be equivalent to the partial derivative of the Lagrangian with respect to the Pauli-basis observable matrix elements. This quantity may be referred to as the “relaxed density matrix in Pauli form,” is classically representable from the output of quantum computer, may be strictly independent of the number of forthcoming derivative perturbations, and may be strictly independent of the response contributions from the classical orbital determination step.
J. For each observable to be differentiated, classically transforming the relaxed active space density matrix from the Pauli-basis representation to the standard second-quantized representation through linear contractions.
K. For each observable to be differentiated, determining a complete Lagrangian for the specification of the classical FOMO-RHF steps taken in A to compute one or more intermediate parameters of the wavefunction. Store this Lagrangian in terms of the classically-representable relaxed density matrix in the active space produced from Step J.
L. For each observable to be differentiated, for any classical elements of the Lagrangian in Step A, solving the appropriate first-order classical response equations to make the Lagrangian stationary with respect to the non-variational classical parameters of the method, e.g., by solving the coupled-perturbed FOMO-RHF (CP-FOMO-RHF) response equations.
M. For each observable to be differentiated, evaluating the total derivative of the observable with respect to the classical overlap and potential matrix elements. Due to the nature of the Lagrangian formalism, this may be equivalent to the partial derivative of the Lagrangian with classical overlap and potential matrix elements. This quantity may be referred to as the “relaxed classical density matrix,” may be classically representable, and may be strictly independent of the number of forthcoming derivative perturbations.
N. Contracting the relaxed classical density matrix with the classical derivatives of the classical overlap and potential matrix elements, for each derivative perturbation. Note that this may be the only stage of the computation where the derivative perturbations are encountered, i.e., the quantities and computational costs (both quantum and classical) in the previous sections are all wholly independent of the number of derivative parameters.

The formal mathematical definition of this embodiment is provided in Sections I and II of the Example below, and the specific Lagrangian for this embodiment is defined in the first equation of Section I.E of the Example below.

In some embodiments, determining the Lagrange multipliers for each set of nonlinear equations to make the part of the Lagrangian corresponding these nonlinear equations stationary, may involve steps to solve linear and or nonlinear equations of one or more variables. Depending on the specific embodiment and the one or more equations in question this may be achieved by means of direct methods such as the direct algorithmic inversion of a matrix on a classical computer (e.g., by means of Cholesky or LU Decomposition), but may also be achieved by means of algebraic solvers that may be approximate, iterative, and/or carried out with the help of a quantum computer. Non-limiting examples of such methods are Direct Inversion of the Iterative Subspace (DIIS), GMRES, MINRES, BICGSTAB, SOR, Jacobi, or Gauss-Seidel. The use of such methods may be advantageous. It may be the case that embodiments using such methods can avoid the computation of certain intermediate quantities altogether, resulting in lower classical and/or quantum computing costs. As a concrete example of where this may happen, consider step H in the previous embodiment. In this case the SA-VQE response equations involve the Hessian of the state averaged energy with respect to the parameters of the quantum circuit. A direct approach to solving the SA-VQE response equations may involve the computation of all quadratically many independent elements of this Hessian matrix with the help of a quantum computer, whereas an embodiment using Direct Inversion of the Iterative Subspace in this step may achieve a sufficiently accurate approximate solution of the SA-VQE response equations from just linearly many distinct quantum computations.

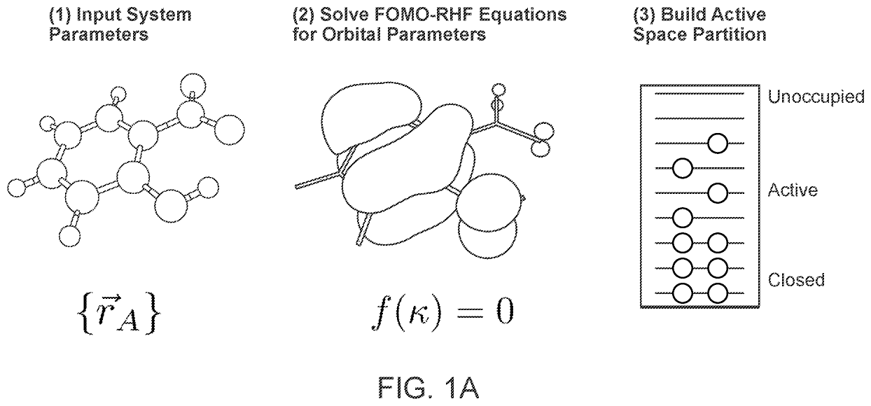

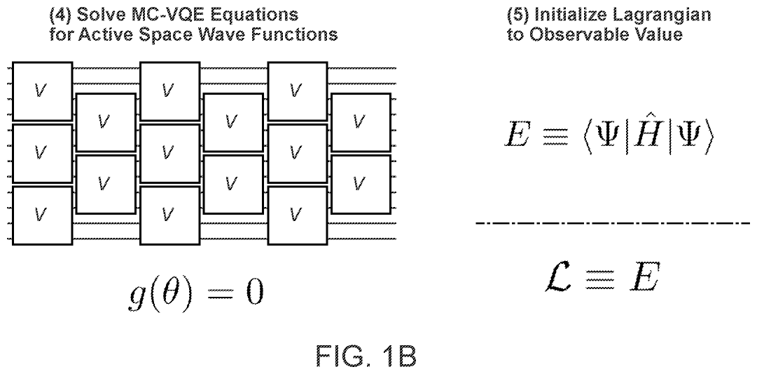

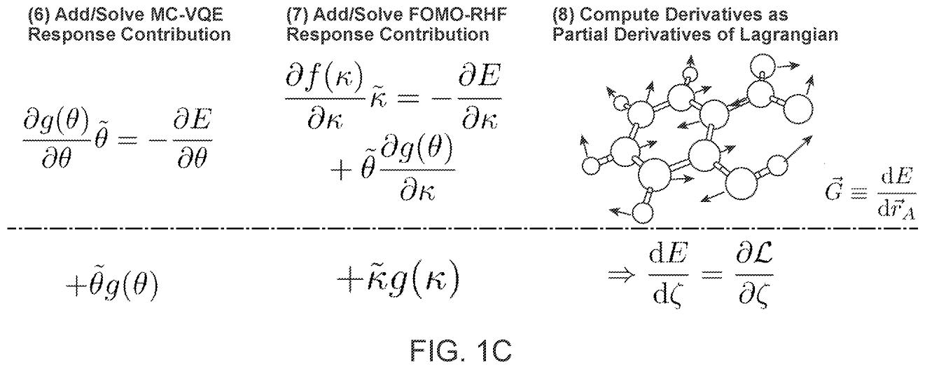

The present disclosure will be further described with reference to FIGS. 1A-1C without wishing to be limited thereby.

FIGS. 1A-1C illustrate an example embodiment of a method according to the disclosure for the case where the wave functions of the fermionic system are represented by FOMO-RHF-MC-VQE (FOMO-RHF orbitals followed by an MC-VQE active space wave computation that may be performed on a quantum computer) and for the specific case where the derivative to be computed is the derivative of the energy of the system with respect to the positions of the nuclei.

Referring to FIGS. 1A-1C: Panel (1), the input nuclear positions {\vec{r}_{A}} which are system parameters in this embodiment are provided or selected (e.g., by a user or a computing system). In Panel (2), the FOMO-RHF nonlinear equations f(κ)=0 are solved classically to determine the orbital parameters K which are intermediate computational parameters. In Panel (3), the orbitals are divided into closed, active, and virtual subsets. In Panel (4), the MC-VQE nonlinear equations g(θ)=0 are solved within the active space to determine the MC-VQE quantum circuit parameters θ, which are intermediate computational parameters. At this point, the fermionic wavefunction |Ψ [symbol] can be prepared on one or more quantum circuits using the intermediate computational parameters κ and θ. In Panel (5) the Lagrangian [symbol] is formally initialized as the observable expectation value to be differentiated, i.e., the energy E≡ [symbol] Ψ|ĤΨ [symbol] defined as the expectation value of the Hamiltonian Ĥ over the fermionic wavefunction |Ψ [symbol] . In Panel (6), Lagrange multipliers \tilde{θ} multiplying the MC-VQE nonlinear equations g(θ)=0 are added to the Lagrangian. The values of these Lagrange multiplier parameters are determined by making the Lagrangian stationary with respect to the MC-VQE quantum circuit parameters θ by solving the MC-VQE linear response equations. In Panel (7), Lagrange multipliers \tilde{κ} multiplying the FOMO-RHF nonlinear equations f(κ)=0 are added to the Lagrangian. The values of these Lagrange multiplier parameters are determined by making the Lagrangian stationary with respect to the FOMO-RHF orbital parameters κ by solving the FOMO-RHF linear response equations. In Panel (8), the first-order total derivatives of the energy E with respect to the input nuclear positions \vec{r}_{A} can be evaluated as the first-order partial derivatives of the Lagrangian [symbol] with respect to the input nuclear positions \vec{r}_{A}. Note that ζ (may represent a generic derivative perturbation, however, in the example of Panel (8), ζ represents the input nuclear positions \vec{r}_{A}. Further note that the response of each intermediate computational parameter κ and θ does not need to be computed separately for each gradient perturbation \vec{r}_{A}.

### Additional Material

In some embodiments, aspects of the disclosure may be implemented on a quantum computer and may be accessed via quantum computing as a service (QCaaS), for example, as described in U.S. Pat. No. 10,614,370.

### EXAMPLE

The present disclosure will be further described in the following non-limiting procedure which outlines the workflow for FOMO-CASCI gradients with FOMO-RHF orbitals and MC-VQE active space solver.

### Detailed Procedure for FOMO-RHF-MC-VQE Gradients

Description of the complete workflow for FOMO-CASCI gradients with FOMO-RHF orbitals and MC-VQE active space solver. This exhibit provides a detailed mathematical example of a specific embodiment of the disclosed method, as well as additional background material describing the conventional/classical Lagrangian approach for first-order derivative properties.

### I. FOMO-RHF-MC-VQE Lagrangian for State Energy Gradients

This section briefly outlines the parametrization and definition of the computational intermediates encountered in the FOMO-RHF-MC-VQE method. These definitions allow us to write down a full Lagrangian for the state energy observables of FOMO-RHF-MC-VQE. Making the Lagrangian stationary with respect to the computational intermediates involves solving a single set of linear response equations for the Lagrange multiplier parameters. This single set of linear response equations exactly decouples into separate classical and quantum pieces. Total derivatives of the FOMO-RHF-MC-VQE state energy with respect to arbitrary system parameters can then be evaluated as partial derivatives of the stationary Lagrangian.

### A. System Parameters

The relevant system parameters are the positions and charges of the nuclei {<\vec{r}_{A}, Z_{A}>}, which also determine the centroids of the Gaussian atomic orbitals {ϕ_{μ}(\vec{r}₁;\vec{r}_{A})}.

### B. Molecular Integrals

The system parameters explicitly determine the values of the atomic orbital spatial molecular integrals, including the overlap integrals,¹ ¹ Note that one will often see the elided notation, e.g. (μ|ν)≡(ϕ_{μ}|ο_{ν}) in various molecular integral quantities and in various types of one-particle basis sets.

$$( {ϕ}_{μ} \vert {ϕ}_{ν} ) ≡ {\int }_{{ℝ}^{3}} {d}^{3} {r}_{1} {ϕ}_{μ} ( {\vec{r}}_{1} ) {ϕ}_{ν} ( {\vec{r}}_{1} )$$

the kinetic energy integrals,

$$( {ϕ}_{μ} \vert - {∇}_{1}^{2} / 2 \vert {ϕ}_{ν} ) ≡ {\int }_{{ℝ}^{3}} {d}^{3} {r}_{1} {ϕ}_{μ} ( {\vec{r}}_{1} ) [ - \frac{1}{2} {∇}_{1}^{2} ] {ϕ}_{ν} ( {\vec{r}}_{1} )$$

the nuclear potential integrals,

$$( {ϕ}_{μ} \vert {\sum }_{A} - {Z}_{A} / {r}_{1 A} \vert {ϕ}_{ν} ) ≡ {\int }_{{ℝ}^{3}} {d}^{3} {r}_{1} {ϕ}_{μ} ( {\vec{r}}_{1} ) [ - \frac{1}{2} {∇}_{1}^{2} ] {ϕ}_{ν} ( {\vec{r}}_{1} )$$

the electron repulsion integrals,

$$( {ϕ}_{μ} {ϕ}_{ν} \vert {ϕ}_{λ} {ϕ}_{σ} ) ≡ \int {\int }_{{ℝ}^{6}} {d}^{3} {r}_{1} {d}^{3} {r}_{2} {ϕ}_{μ} ( {\vec{r}}_{1} ) {ϕ}_{ν} ( {\vec{r}}_{1} ) \frac{1}{{r}_{12}} {ϕ}_{λ} ( {\vec{r}}_{2} ) {ϕ}_{σ} ( {\vec{r}}_{2} )$$

and the scalar nuclear repulsion energy,

$${E}_{Nuc} ≡ {\sum }_{A > B} \frac{{Z}_{A} {Z}_{B}}{{r}_{AB}}$$

Note that one commonly sees the one-electron integrals as an intermediate,

$$( {ϕ}_{μ} \vert \hat{h} \vert {ϕ}_{ν} ) ≡ ( {ϕ}_{μ} \vert - {∇}_{1}^{2} / 2 \vert {ϕ}_{ν} ) + ( {ϕ}_{μ} \vert {\sum }_{A} - {Z}_{A} / {r}_{1 A} \vert {ϕ}_{ν} )$$

### C. FOMO-RHF Orbitals

We formally parametrize the FOMO-RHF spatial orbitals as,

$${ϕ}_{p} ( {\vec{r}}_{1} ) ≡ {\sum }_{μ} {\sum }_{{p}^{′}} {C}_{μ {p}^{′}} {/ [ exp ( \hat{κ} ) ]}_{{pp}^{′}} {ϕ}_{μ} ( {\vec{r}}_{1} )$$

Where the atomic orbitals are {ϕ_{μ}(\vec{r}₁)}, C_{μp} are the FOMO-RHF orbital coefficients, and,

$${κ}_{p q} = - {κ}_{q p}$$

are the orbital rotation generators. Note that in the working equations, we focus only on the unique nontrivial κ_{p>q} block. At the moment there is redundancy between κ_{pq} and C_{μp} in the definition of the orbitals—this redundancy will be removed by additionally constraining κ_{pq}=0, and allows for the orbital response (encoded in the κ_{pq} term) and orbital orthonormality (encoded in the C_{μp}) contributions to the gradient to be dealt with separately below.

κ_{pq} is defined to be zero,

κ_{pq}=0

The orbitals are defined to be orthonormal,

$$( {ϕ}_{p} \vert {ϕ}_{q} ) = {C}_{μ p} ( {ϕ}_{μ} \vert {ϕ}_{ν} ) {C}_{ν q} = {δ}_{p q}$$

The orbitals are defined to make the FOMO-RHF Fock matrix diagonal,

$${f}_{p q} ≡ ( p \vert \hat{h} \vert q ) + 2 {\sum }_{r} {n}_{r} ( p q \vert r r ) - {\sum }_{r} {n}_{r} ( p r \vert q r ) = {δ}_{p q} {ϵ}_{p}$$

where ϵₚ is the diagonal Fock matrix element or “orbital energy”

$${ϵ}_{p} ≡ {f}_{pp} ≡ ( p \vert \hat{h} \vert p ) + 2 {\sum }_{r} {n}_{r} ( pp \vert rr ) - {\sum }_{r} {n}_{r} ( pr \vert pr )$$

The occupation numbers are chosen from user-specified occupation number sigmoid functions applied to the orbital energies,

$${n}_{r} ≡ f ( {ϵ}_{r} ; μ )$$

where the adjustable “Fermi-level” or “chemical potential” parameter u is chosen to constrain the sum of the occupation numbers to a user-specified total value, N_{FOMO},

$${\sum }_{r} {n}_{r} = {\sum }_{r} f ( {ϵ}_{r} ; μ ) = {N}_{FOMO}$$

### D. MC-VQE Active Space Wavefunctions

We formally parametrize the MC-VQE wavefunctions as,

$$\vert {Ψ}^{Θ} 〉 ≡ {\sum }_{{Θ}^{′}} \hat{U} ( \{ {θ}_{g} \} ) \vert {Φ}^{{Θ}^{′}} 〉 {V}_{{Θ}^{′} Θ}$$

Here {|Φ^{Θ} [symbol] } are reference states which are classically and quantumly tractable. In this work, these reference states are chosen to be selected configuration state functions (CSFs), and therefore have no internal computational parameters other than the underlying orbital parameters.

Û({θ_{g}}) is a state-averaged VQE entangler circuit with quantum circuit parameters θ_{g}. These parameters are chosen to minimize the state-averaged VQE energy,

$$\begin{matrix}{θ}_{g}^{*} = {argmin}_{{θ}_{g}} ( {\sum }_{Θ} {ω}_{Θ} 〈 {Φ}^{Θ} \vert {\hat{U}}^{†} ( \{ {θ}_{g} \} ) \hat{H} \hat{U} ( \{ {θ}_{g} \} ) \vert {Φ}^{Θ} 〉 ) \\ ≡ {argmin}_{{θ}_{g}} ( {\sum }_{Θ} {ω}_{Θ} 〈 {Γ}^{Θ} \vert \hat{H} \vert {Γ}^{Θ} 〉 )\end{matrix}$$

Here {w_{Θ}} are a set of user-defined non-increasing state averaging weights. Ĥ is the molecular Hamiltonian of the system, and can be written in terms of second quantized operators or Pauli operators as linear combinations of the molecular potential integrals (p|ĥ|q) and (pq|rs).

The weak form of the SA-VQE energy minimization condition is the first-order stationary condition,

$$\frac{\partial }{\partial {θ}_{g}} {\sum }_{Θ} {ω}_{θ} 〈 {Γ}^{Θ} \vert \hat{H} \vert {Γ}^{Θ} 〉 = 0$$

In practice, this condition is used to define the SA-VQE entangler circuit parameters θ_{g}. The MC-VQE subspace eigenvectors V_{Θ′Θ} are chosen to diagonalize the MC-VQE subspace Hamiltonian,

$${\sum }_{{Θ}^{′}} {ℋ}_{{ΘΘ}^{′}} {V}_{{Θ}^{′} {Θ}^{″}} = {V}_{{ΘΘ}^{″}} {E}^{Θ}$$

additionally subject to the constraint of orthonormality,

$${\sum }_{{Θ}^{″}} {V}_{{ΘΘ}^{″}} {V}_{{Θ}^{′} {Θ}^{″}} = {δ}_{{ΘΘ}^{′}} , {\sum }_{{Θ}^{″}} {V}_{{Θ}^{″} Θ} {V}_{{Θ}^{″} {Θ}^{′}} = {δ}_{{ΘΘ}^{′}}$$

The MC-VQE state energies E^{Θ} have the expectation value property,

$${E}^{Θ} = 〈 {Ψ}^{Θ} \vert \hat{H} \vert {Ψ}^{Θ} 〉$$

In practice, these MC-VQE states are defined to be active in only a strict active space of the FOMO-RHF orbitals. This provides for reduced quantum circuit resource requirements, and lowers the cost of forming certain classical computational intermediates, but does not affect the structure of the FOMO-RHF-MC-VQE Lagrangian (i.e., all of the same terms would be present even if all FOMO-RHF orbitals were included in the active space).

### E. FOMO-RHF-MC-VQE Lagrangian

The FOMO-RHF-MC-VQE Lagrangian is now,

$${ℒ}^{Θ} ≡ 〈 {Ψ}^{Θ} \vert \hat{H} \vert {Ψ}^{Θ} 〉 + {\sum }_{g} {\tilde{θ}}_{g} \frac{\partial }{\partial {θ}_{g}} {\sum }_{Θ} {w}_{Θ} 〈 {Γ}^{Θ} \vert \hat{H} \vert {Γ}^{Θ} 〉 + {\sum }_{p > q} {\tilde{κ}}_{p q} {f}_{p q} + {\sum }_{p} {\tilde{ξ}}_{p} [ {ϵ}_{p} - {f}_{p p} ] + {\sum }_{p} {\tilde{η}}_{p} [ {n}_{p} - f ( {ϵ}_{p} ; μ ) ] + \tilde{Ω} [ {\sum }_{p} {n}_{p} - {N}_{F O M O} ] + {\sum }_{p q} {\tilde{w}}_{p q} [ {C}_{μ p} ( {ϕ}_{μ} \vert {ϕ}_{ν} ) {C}_{ν q} - {δ}_{p q} ] + {\sum }_{p > q} {\tilde{\tilde{κ}}}_{p q} {κ}_{p q}$$

The first line of this Lagrangian is the observable E^{Θ}. The second line of this Lagrangian is the state-averaged VQE (SA-VQE) stationary condition. The third and fourth lines of this Lagrangian are the FOMO-RHF equations. The fifth line of this Lagrangian is the the orbital orthonormality condition. The sixth line of this Lagrangian is the zero definition of the orbital rotation parameters to remove the redundancy between C_{μp} and κ_{pq}.

The free parameters of this Lagrangian are,
κ_{p>q}—orbital rotation parameters.
C_{μp}—orbital coefficients.
nₚ—orbital occupation numbers.
ϵₚ—orbital eigenvalues.
μ—“Fermi level” or “chemical potential.”
θ_{g}—SA-VQE entangler circuit parameters.

The Lagrange multiplier parameters of this Lagrangian are,
[symbol] _{p>q}—enforces κ_{pq}=0. Note that no contributions to the final derivatives arise from this term, as no system parameters are involved. This term is included only for formal completeness.
\tilde{w}_{p>q}—enforces orthonormality of orbitals, e.g., to account for changes in the 1-particle metric (μ|v) as the nuclear and atomic orbital geometry changes. Also referred to as the “energy-weighted density matrix.” Note that one must exploit the symmetry w_{pq}=w_{qp} to obtain the formally correct number of response equations.
\tilde{Ω}—enforces the constraint of total FOMO-RHF occupation number.
\tilde{η}ₚ—defines the orbital occupation numbers.
\tilde{ξ}ₚ—defines the orbital eigenvalues.
\tilde{κ}_{p>q}—enforces that the FOMO-RHF orbitals diagonalize the Fock matrix.
\tilde{θ}_{g}—enforces that the SA-VQE quantum circuit parameters make the state-averaged VQE energy stationary.

Note that there are no free parameters or terms in this Lagrangian for the MC-VQE reference states|Ω [symbol] or for the MC-VQE subspace eigenvectors V_{Θ′Θ}. For the configuration-state-function reference states used in this implementation of MC-VQE, there are no additional adjustable parameters beyond the orbital parameters, so there are no response contributions from the reference states. For the MC-VQE subspace eigenvectors, the state energy E^{Θ} is already variational in the constrained orthogonal support of these parameters, so there is no response contribution from the MC-VQE subspace eigenvectors for this specific observable quantity.

### F. FOMO-RHF-MC-VQE Response Equations

At this point, one can form the single set of united FOMO-RHF-MC-VQE response equations by setting.

$$\frac{\partial ℒ}{\partial {γ}_{T}} = 0 ∀ {γ}_{T}$$

Where γ is one of the seven classes of free parameters and T is the index of that parameter. This yields a single set of square, nonsymmetric linear equations for the corresponding Lagrange multipliers \tilde{γ}_{T}. As with many classical methods, the particular structure of the FOMO-RHF-MC-VQE method mandates that certain blocks of the FOMO-RHF-MC-VQE response equations analytically separate, yielding a nested sequence of smaller linear response equations. In particular, we encounter the following blocks of nested response equations in FOMO-RHF-MC-VQE (line numbers referenced with respect to the first equation in section I.E),
Making the Lagrangian stationary with respect to the SA-VQE entangler circuit parameters θ_{g} yields a RHS with contributions from line 1 and a LHS with contributions from line 2. These are the SA-VQE response equations.
Making the Lagrangian stationary with respect to the orbital parameters κ_{pq}, ϵₚ, nₚ, and μ determines the Lagrange multipliers \tilde{κ}_{pq}, \tilde{ξ}ₚ, \tilde{η}ₚ, and \tilde{Ω}, and yields a RHS with contributions from line 1 and 2 and a LHS with contributions from lines 3 and 4.
Making the Lagrangian stationary with respect to C_{μp} determines the Lagrange multipliers \tilde{w}_{pq}, and yields an analytically solvable linear equation with a RHS from lines 1-4 and a LHS from line 5.

### G. Intermediate Density Matrices

Note that at first glance, it seems that we will need to compute observables corresponding to many different kinds of partial derivatives to evaluate the right-hand sides of the response equations. For instance, consider the partial derivative contributions from the observable term [symbol] Ψ^{Θ}|Ĥ|Ψ^{Θ} [symbol] . To form the RHS of the SA-VQE response equation, we will surely need,

$$\frac{\partial 〈 {Ψ}^{Θ} \vert \hat{H} \vert {Ψ}^{Θ} 〉}{\partial {θ}_{g}}$$

But then to form the RHS of the CP-FOMO-RHF orbital response equations, it seems that we will need,

$$\frac{\partial 〈 {Ψ}^{Θ} \vert \hat{H} \vert {Ψ}^{Θ} 〉}{\partial {κ}_{p q}} , \frac{\partial 〈 {Ψ}^{Θ} \vert \hat{H} \vert {Ψ}^{Θ} 〉}{\partial {ϵ}_{p}} , \frac{\partial 〈 {Ψ}^{Θ} \vert \hat{H} \vert {Ψ}^{Θ} 〉}{\partial {n}_{p}} , \frac{\partial 〈 {Ψ}^{Θ} \vert \hat{H} \vert {Ψ}^{Θ} 〉}{\partial μ}$$

and additional partial derivatives for terms further down the stack. However, it is important to recognize that the orbital parameters and system parameters only entered into the definitions of the MC-VQE observables through their role in defining the potential matrix elements (p|ĥ|q) and (pq|rs) after the determination of the FOMO-RHF orbital parameters. Therefore, it may considerably simplify the notation to define intermediate derivatives such as,

$${γ}_{p q}^{Θ} = \frac{\partial 〈 {Ψ}^{Θ} \vert \hat{H} \vert {Ψ}^{Θ} 〉}{\partial ( p \vert \hat{h} \vert q )}$$

$$and ,$$

$${Γ}_{p q r s}^{Θ} = \frac{\partial 〈 {Ψ}^{Θ} \vert \hat{H} \vert {Ψ}^{Θ} 〉}{\partial ( pq \vert rs )}$$

Some algebra shows that, due to the linearity of the Hamiltonian,

$${E}^{Θ} = {E}_{N u c} + {\sum }_{p q} {γ}_{p q}^{Θ} ( p \vert \hat{h} \vert q ) + {\sum }_{p q r s} {Γ}_{p q r s}^{Θ} ( p q \vert r s )$$

Any subsequent derivative in the orbital parameters can then be computed by the chain rule, e.g.,

$$\frac{\partial 〈 {Ψ}^{Θ} \vert \hat{H} \vert {Ψ}^{Θ} 〉}{\partial μ} = {\sum }_{pq} {γ}_{pq}^{Θ} \frac{\partial 〈 p \vert \hat{h} \vert q 〉}{\partial μ} + {\sum }_{pqrs} {Γ}_{pqrs}^{Θ} \frac{\partial ( pq \vert rs )}{\partial μ}$$

### II. Detailed FOMO-RHF-MC-VQE State Energy Gradient Algorithmic Procedure

This section details the complete computational steps to be undertaken to compute the FOMO-RHF-MC-VQE ansatz parameters, state energies, and gradients of these state energies with respect to the nuclear positions. This section constitutes the finished working equations obtained by following the formal Lagrangian procedure detailed above.

### A. Indices

A, B, C, D—nuclear indices.
μ, ν, λ, σ—atomic orbital indices.
p, q, r, s—general molecular orbital indices.
i, j, k, l—core molecular orbital indices.
t, u, v, w—active molecular orbital indices.
a, b, c, d—virtual molecular orbital indices.
Θ—adiabatic electronic state index.
P—Pauli string index.
g—SA-VQE entangler circuit parameter index.
T—quantum parameter shift rule index.
ξ—nuclear gradient index.

### B. Problem Geometry Specification (Classical)

Input the molecular geometry {<\vec{r}_{A}, Z_{A}>}.

Input the atomic orbital basis {ϕ_{μ}(\vec{r}₁;{\vec{r}_{A}})}.

### C. FOMO-RHF Orbital Determination (Classical)

### 2. Parameters

Nᵢ—number of closed orbitals
Nₜ—number of active (fractionally occupied) orbitals
Nₐ—number of virtual orbitals
N—number of fractional electrons
f(ϵᵣ;μ)—functional form of occupation number sigmoid function
β—inverse electronic temperature parameter
δ_{Canonical}—canonical orthogonalization eigenvalue cutoff
δ_{FOMO-RHF-G}—SCF convergence criterion in maximum element of orbital gradient
δ_{FOMO-RHF-H}—SCF convergence criterion in change in enthalpy
Auxiliary parameters for initial density matrix guess D_{μν}⁰
Auxiliary parameters for dampling/DIIS stabilization
Auxiliary parameters for non-Aufbau occupation schemes
Cutoff values for molecular integrals

### 3. Procedure

Compute the nuclear repulsion energy,

$${E}_{N u c} ≡ {\sum }_{A > B} \frac{{Z}_{A} {Z}_{B}}{{r}_{A B}}$$

Compute the atomic orbital spatial overlap matrix (real, square, SPSD),

$${S}_{μν} ≡ ( μ \vert ν ) ≡ {d}^{3} {r}_{1} {ϕ}_{μ} ( {\vec{r}}_{1} ) {ϕ}_{ν} ( {\vec{r}}_{1} )$$

Compute the canonical orthogonalization matrix (real, rectangular),

$${X}_{μ p} ≡ {U}_{μ p} {s}_{p}^{- 1 / 2} : {s}_{p} > {δ}_{C a n o n ical}$$

where the (real) eigendecomposition of the overlap matrix is,

$${S}_{μ ν} = {\sum }_{p} {U}_{μ p} {s}_{p} {U}_{ν p} : {\sum }_{p} {u}_{μ p} {u}_{ν p} = {δ}_{μ ν} ,$$

$${\sum }_{μ} {U}_{μ p} {U}_{μ q} = {δ}_{p q} , {s}_{p} \geq 0$$

such that the orthogonalizer has the property that,

$${\sum }_{μ ν} {X}_{μ p} {S}_{μ ν} {X}_{ν q} = {δ}_{p q}$$

Note that the canonical orthogonalization cutoff parameter δ_{Canonical} may remove linear combinations of atomic orbital basis functions that are numerically redundant. Therefore X_{μp} is a rectangular matrix with Nₚ≤N_{μ}.

Compute the atomic orbital electronic kinetic energy matrix (real, square, SPSD),

$${T}_{μ ν} ≡ ( μ \vert - {∇}_{1}^{2} / 2 \vert ν ) ≡ {d}^{3} {r}_{1} {ϕ}_{μ} ( {\vec{r}}_{1} ) [ - \frac{{∇}_{1}^{2}}{2} ] {ϕ}_{ν} ( {\vec{r}}_{1} )$$

Compute the atomic orbital nuclear attraction potential matrix (real, square, SNSD),

$${V}_{μ ν} ≡ ( μ \vert {\sum }_{A} - {Z}_{A} / {r}_{1 A} \vert ν ) ≡ {d}^{3} {r}_{1} {ϕ}_{μ} ( {\vec{r}}_{1} ) [ - {\sum }_{A} \frac{{Z}_{A}}{{r}_{1 A}} ] {ϕ}_{ν} ( {\vec{r}}_{1} )$$

Compute the atomic orbital core Hamiltonian matrix (real, square, symmetric),

$${H}_{μ ν} ≡ {T}_{μ ν} + {V}_{μ ν}$$

Compute the initial guess to the density matrix (real, square, symmetric),

D_{μν}←D_{μν}⁰

Begin the FOMO-RHF iterative SCF procedure.

Compute the atomic orbital Coulomb matrix (real, square, SPSD),

$${J}_{μ ν} ≡ {\sum }_{λ σ} ( μ ν \vert λ σ ) {D}_{λ σ}$$

Compute the atomic orbital exchange matrix (real, square, SPSD),

$${K}_{μ ν} ≡ {\sum }_{λ σ} ( μ λ \vert ν σ ) {D}_{λ σ}$$

Here the atomic orbital electron repulsion integrals (real, 4-square, 8-fold symmetric, SPSD in J and K compound orderings),

$$( μ ν \vert λ σ ) ≡ \int {\int }_{{ℝ}^{6}} d {r}_{1} d {r}_{2} {ϕ}_{μ} ( {\vec{r}}_{1} ) {ϕ}_{ν} ( {\vec{r}}_{1} ) \frac{1}{{r}_{12}} {ϕ}_{λ} ( {\vec{r}}_{2} ) {ϕ}_{σ} ( {\vec{r}}_{2} )$$

Compute the atomic orbital Fock matrix (real, square, symmetric),

$${F}_{μ ν} ≡ {H}_{μ ν} + 2 {J}_{μ ν} - {K}_{μ ν}$$

Compute the FOMO-RHF internal energy (real, first-order convergence),

$${E}_{F O M O - R H F} ≡ {E}_{N u c} + {\sum }_{μ ν} {D}_{μ ν} {H}_{μ ν} + {\sum }_{μ ν} {D}_{μ ν} {F}_{μ ν}$$

Compute the FOMO-RHF entropy contribution (real, first-order convergence, see below),

TS_{FOMO-RHF}

Compute the FOMO-RHF enthalpy (real, variational, second-order convergence),

$${H}_{F O M O - R H F} = {E}_{F O M O - R H F} - T {S}_{FOMO - RHF}$$

Compute the change in FOMO-RHF enthalpy from the last iteration (or from 0 if the first iteration),

$$Δ {H}_{F O M O - R H F} ≡ {H}_{F O M O - R H F}^{( I )} - {H}_{F O M O - R H F}^{( I - 1 )}$$

|ΔH_{FOMO-RHF}| converges quadratically to zero at a stationary point of the FOMO-RHF equations, and is used as a convergence criterion by comparing with a threshold δ_{FOMO-RHF-H}.

Compute the commutator between the Fock matrix and the density matrix in the orthogonal orbital basis. also known as the orbital gradient (real, square, antisymmetric),

$${G}_{p q} ≡ {\sum }_{μ ν λ σ} {X}_{μ p} {S}_{μ ν} {D}_{ν λ} {F}_{λ σ} {X}_{σ q} - {X}_{μ q} {S}_{μ ν} {D}_{ν λ} {F}_{λ σ} {X}_{σ p}$$

|G_{pq}|_{∞} converges linearly to zero at a stationary point of FOMO-RHF equations, and is used as a convergence criterion by comparing with a threshold δ_{FOMO-RHF-G}.

If desired, perform damping and/or DIIS-type extrapolation of the Fock matrix, using F_{μν} as the state vector and G_{pq} as the error vector.

Transform the Fock matrix to the orthonormal basis (real, square, symmetric),

$${F}_{p q}^{( 2 )} ≡ {\sum }_{μ ν} {X}_{μ p} {F}_{μ ν} {X}_{ν q} \qquad ( 2 )$$

Diagonalize the orthonormal basis Fock matrix to form the orbital eigenvectors Uₚᵣ (real, square. orthogonal), and the orbital eigenvalues ϵᵣ (real),

$${F}_{p q}^{( 2 )} = {\sum }_{r} {U}_{p r} {ϵ}_{r} {U}_{q r} : {\sum }_{r} {U}_{p r} {U}_{q r} = {\sum }_{r} {U}_{r p} {U}_{r q} = {δ}_{p q}$$

Compute the atomic orbital orbital spatial orbital coefficients (real, rectangular),

$${C}_{μ p} ≡ {\sum }_{q} {X}_{μ q} {U}_{q p}$$

Compute the orbital occupation numbers nᵣ (real) according to shape functions f(ϵᵣ; μ) parametrized by the chemical potential parameter μ. Vary μ via bisection or similar 1D root finding technique so that the sum of the orbital occupation numbers equals the user-specified total a electron number N,

$${n}_{r} ≡ f ( {ϵ}_{r} , μ ) : {n}_{r} ∈ [ 0 , 1 ] , {\sum }_{r} {n}_{r} = N$$

Compute the updated density matrix (real, square, SPSD),

$${D}_{μ ν} = {\sum }_{r} {C}_{μ r} {n}_{r} {C}_{ν r}$$

Repeat the FOMO-RHF iterations until the SCF procedure converges.

### D. ASCI Second-Quantized Hamiltonian Determination (Classical)

### 1. Targets

Eₑₓₜ—external energy of nuclei and core orbitals.
hₜᵤ—active space core Hamiltonian integrals.
(tu|vw)—active space ERIs.

### 2. Parameters

Nᵢ—number of closed orbitals
Nₜ—number of active orbitals
Nₐ—number of virtual orbitals
Auxiliary parameters for non-Aufbau occupation schemes
Cutoff values for molecular integrals

### 3. Procedure

Divide the spatial FOMO-RHF orbitals {ϕₚ(\vec{r}₁)} into the three nonoverlapping subsets of core orbitals {ϕᵢ(\vec{r}₁)}, active orbitals {ϕₜ(\vec{r}₁)}, and virtual orbitals {ϕₐ(\vec{r}₁)}.

Compute the external energy of the nuclei and core orbitals (real),

$${E}_{e x t} ≡ {E}_{n u c} + 2 {\sum }_{i} ( i \vert - {∇}_{1}^{2} / 2 - {\sum }_{A} {Z}_{A} / {r}_{1 A} \vert i ) + 2 {\sum }_{ij} ( i i \vert j j ) - {\sum }_{ij} ( i j \vert ij ) = {E}_{n u c} + {\sum }_{μ ν} {D}_{μ ν}^{C o r e} ( 2 {H}_{μ ν} + 2 {J}_{μ ν} [ {D}_{μ ν}^{C o r e} ] - {K}_{μ ν} [ {D}_{μ ν}^{C o r e} ] )$$

Compute the active space core Hamiltonian integrals (real, square, symmetric),

$${h}_{t u} ≡ ( t \vert - {∇}_{1}^{2} / 2 - {\sum }_{A} {Z}_{A} / {r}_{1 A} \vert u ) + {\sum }_{i} 2 ( t u \vert i i ) - {\sum }_{i} ( t i \vert ui ) = {\sum }_{μ ν} {C}_{μ t} ( {H}_{μ ν} + 2 {J}_{μ ν} [ {D}_{μ ν}^{C o r e} ] - {K}_{μ ν} [ {D}_{μ ν}^{C o r e} ] ) {C}_{ν u}$$

Compute the active space ERIs (real, 4-square, 8-fold symmetric, SPSD in J and K compound orderings),

$$\begin{matrix}( tu \vert vw ) ≡ {\sum }_{μ v λσ} {C}_{μ t} {C}_{vu} ( μ v \vert λσ ) {C}_{λ v} {C}_{σ w} \\ = {\sum }_{μ v} {C}_{μ t} {C}_{vu} {J}_{μ v} [ {D}_{λσ}^{vw} ≡ {C}_{λ v} {C}_{σ w} ]\end{matrix}$$

Above, the core OPDM (real, square, SPSD, idempotent relative to S_{μν}) is,

$${D}_{μ v}^{Core} ≡ {\sum }_{i} {C}_{μ i} {C}_{vi}$$

### E. ASCI Pauli Hamiltonian Determination (Classical)

### 1. Targets

\hat{Π}_{P}—nontrivial Pauli strings of Jordan-Wigner electronic Hamiltonian.
v_{P}-coefficients of Pauli strings of Jordan-Wigner electronic Hamiltonian.

### 2. Procedure

Compute the Pauli string coefficients v_{P} (real, addressing symmetrical Pauli strings with even numbers of Ŷ operators) needed to transform the ASCI Hamiltonian from spin-restricted second quantized representation in a N_{act} spatial orbital Fock space to Jordan-Wigner Pauli representation in a 2N_{act} qubit space.

$$\begin{matrix}\hat{H} = {E}_{Ext} + {\sum }_{tu} {h}_{tu} ( {t}^{+} u + {\overline{t}}^{+} \overline{u} ) + \\ \frac{1}{2} {\sum }_{tuvw} ( tu \vert vw ) [ 2 {\overline{t}}^{+} \overline{u} {v}^{+} w + {t}^{+} {v}^{+} wu + {\overline{t}}^{+} {\overline{v}}^{+} \overline{u} \overline{w} ] \\ = {\sum }_{P} {v}_{P} {\hat{Π}}_{P}\end{matrix} \qquad ( 1 )$$

where \hat{Π}_{P} represents each Pauli operator string with nonzero coefficient. The coefficients v_{P} are computed as fixed linear combinations of Hamiltonian matrix elements Eₑₓₜ, hₜᵤ, and (tu|vw). The explicit details of this transformation can be found in the appendix below.

### F. MC-VQE ASCI Solution (Hybrid Quantrum/Classical)

### 1. Targets

Ŵ^{Θ}—reference state quantum circuits
Û({θ_{g}})—SA-VQE entangler circuit with optimized coefficients
V_{Θ′Θ}—MC-VQE subspace eigenvectors

### 2. Parameters

N_{α}—number of α electron target quantum number
N_{β}—number of β electron target quantum number
S—spin-squared target quantum number
N_{Θ}—number of target MC-VQE adiabatic wavefunctions
w_{Θ}—SA-VQE weights
Auxiliary parameters for construction and selection of reference statevectors {|Ω^{Θ} [symbol] }
Auxiliary parameters for construction and initialization of SA-VQE entangler circuits Û ({θ_{g}})
Auxiliary parameters for optimization and convergence of SA-VQE entangler circuit parameters {θ_{g}}

### 3. Procedure

Determine the classically-tractable reference states |Ω^{Θ} [symbol] and quantum circuits Ŵ^{Θ} to prepare these states in the Jordan-Wigner computational basis from the fidducial state |\vec{0} [symbol] ,

$$\vert {Φ}^{Θ} 〉 ≡ {\hat{W}}^{Θ} \vert \vec{0} 〉$$

The reference states must be orthonormal and eigenfunctions of the α-number, β-number, and spin-squared quantum number operators with target quantum number eigenvalues. See the technical appendix below for more details and an explicit recipe for reference closed-shell determinant, singly-excited open shell configurations, and diagonally doubly-excited closed-shell determinants. Append each reference state with the state-averaged VQE (SA-VQE) entangler circuit Û ({θ_{g}}) to form the corresponding entangled reference state,

$$\vert {Γ}^{Θ} 〉 ≡ \hat{U} ( \{ {θ}_{g} \} ) \vert {Φ}^{Θ} 〉$$

The SA-VQE entangler circuit must commute with the α-number, β-number, and spin-squared quantum number operators. See the technical appendix below for one construction of

Optimize the SA-VQE entangler circuit parameters {θ_{G}} to minimize the state-averaged entangled reference state energy, also referred to as the “SA-VQE state-averaged energy” (real, observable),

$$\overline{E} ≡ {\sum }_{Θ} {w}_{Θ} 〈 {Γ}^{Θ} \vert \hat{H} \vert {Γ}^{Θ} 〉$$

This optimization will require the diagonal elements of the MC-VQE subspace Hamiltonian (real, quantum observable),

$${ℋ}_{ΘΘ} ≡ 〈 {Γ}^{Θ} \vert \hat{H} \vert {Γ}^{Θ} 〉$$

which are evaluated by Pauli density matrix observations of the entangled reference states (real, primary quantum observable),

$${Λ}_{P}^{ΘΘ} ≡ 〈 {Γ}^{Θ} \vert {\hat{Π}}_{P} \vert {Γ}^{Θ} 〉$$

which can then be classically contracted with the coefficients of the Pauli strings in the Jordan-Wigner representation of the ASCI Hamiltonian,

$$⇒ {ℋ}_{ΘΘ} = {\sum }_{P} {v}_{P} {Λ}_{P}^{ΘΘ}$$

This optimization is also greatly assisted by the existence of efficient routines for the evaluation of the parameter gradient of the SA-VQE state-averaged energy (real, quantum observable),

$$\frac{d \overline{E}}{d {θ}_{g}} = {\sum }_{Θ} {w}_{Θ} \frac{d}{d {θ}_{g}} 〈 {Γ}^{Θ} \vert \hat{H} \vert {Γ}^{Θ} 〉 = {\sum }_{Θ} {w}_{Θ} \frac{d}{d {θ}_{g}} {ℋ}^{ΘΘ}$$

Depending on the nature of the entangler circuit construction, this can be accomplished with additional quantum measurements by the quantum parameter shift rule (real, quantum observable),

$$\begin{matrix}\frac{d}{d {θ}_{g}} {ℋ}^{ΘΘ} = \frac{d}{d {θ}_{g}} 〈 {Γ}^{Θ} \vert \hat{H} \vert {Γ}^{Θ} 〉 \\ = {\sum }_{T} {α}_{T} 〈 {Γ}^{Θ} ( \{ {θ}_{g} + {ζ}_{T} ; {θ}_{{g}^{′} \neq g} \} ) \vert \hat{H} \vert {Γ}^{Θ} ( \{ {θ}_{g} + {ζ}_{T} ; {θ}_{{g}^{′} \neq g} \} ) 〉\end{matrix}$$

Here the parameter shifts and weights {<ζ_{T}, α_{T}>} are specialized to the particular gate tomography. For the specific quantum-number-preserving entangler gates used in the technical appendix, a four-point parameter shift rule suffices. For more details, see the technical appendix. As with the diagonal MC-VQE subspace Hamiltonian elements, the elements of the quantum parameter shift stencil are broken down into Pauli density matrix terms (real, primary quantum observable),

$$\begin{matrix}\frac{d}{d {θ}_{g}} {Λ}_{P}^{ΘΘ} ≡ \frac{d}{d {θ}_{g}} 〈 {Γ}^{Θ} \vert {\hat{Π}}_{P} \vert {Γ}^{Θ} 〉 \\ = {\sum }_{T} {α}_{T} 〈 {Γ}^{Θ} ( \{ {θ}_{g} + {ζ}_{T} ; {θ}_{{g}^{′} \neq g} \} ) \vert {\hat{Π}}_{P} \vert {Γ}^{Θ} ( \{ {θ}_{g} + {ζ}_{T} ; {θ}_{{g}^{′} \neq g} \} ) 〉\end{matrix}$$

which can then be classically contracted with the coefficients of the Pauli strings in the Jordan-Wigner representation of the ASCI Hamiltonian,

$$⇒ \frac{d}{d {θ}_{g}} {ℋ}_{ΘΘ} = {\sum }_{P} {v}_{P} \frac{d}{d {θ}_{g}} {Λ}_{P}^{ΘΘ}$$

Repeat optimization loop until converged.

Evaluate the off-diagonal MC-VQE subspace Hamiltonian matrix elements (real, indirect quantum observable),

$${ℋ}^{Θ \neq {Θ}^{′}} ≡ 〈 {Γ}^{Θ} \vert \hat{H} \vert {Γ}^{{Θ}^{′}} 〉$$

This can be formed by a difference of two direct quantum observables,

$${ℋ}^{Θ \neq {Θ}^{′}} ≡ \frac{1}{2} [ 〈 {Γ}_{+}^{{ΘΘ}^{′}} \vert \hat{H} \vert {Γ}_{+}^{{ΘΘ}^{′}} 〉 - 〈 {Γ}_{-}^{{ΘΘ}^{′}} \vert \hat{H} \vert {Γ}_{-}^{{ΘΘ}^{′}} 〉 ]$$

Where the entangled interfering reference states are,

$$\vert {Γ}_{\pm }^{{ΘΘ}^{′}} 〉 ≡ \hat{U} ( \{ {θ}_{g} \} ) \vert {Φ}_{\pm }^{{ΘΘ}^{′}} 〉$$

and the classically and quantumly tractable interfering reference states are,

$$\vert {Φ}_{\pm }^{{ΘΘ}^{′}} 〉 ≡ \frac{1}{\sqrt{2}} [ \vert {Φ}^{Θ} 〉 \pm \vert {Φ}^{{Θ}^{′}} 〉 ] ≡ {\hat{W}}_{\pm }^{{ΘΘ}^{′}} \vert \vec{0} 〉$$

As before, we first evaluate the Pauli density matrix elements of the entangled interfering reference states (real, primary quantum observable),

$${Λ}_{P}^{Θ \neq {Θ}^{′}} ≡ \frac{1}{2} [ 〈 {Γ}_{+}^{{ΘΘ}^{′}} \vert {\hat{Π}}_{P} \vert {Γ}_{+}^{{ΘΘ}^{′}} 〉 - 〈 {Γ}_{-}^{{ΘΘ}^{′}} \vert {\hat{Π}}_{P} \vert {Γ}_{-}^{{ΘΘ}^{′}} 〉 ]$$

which can then be classically contracted with the coefficients of the Pauli strings in the Jordan-Wigner representation of the ASCI Hamiltonian,

$$⇒ {ℋ}_{Θ \neq {Θ}^{′}} = {\sum }_{P} {v}_{P} {Λ}_{P}^{Θ \neq {Θ}^{′}}$$

Classically diagonalize the subspace Hamiltonian to find the MC-VQE subspace eigenvectors V_{ΘΘ′} (real, square, orthogonal) and the MC-VQE eigenvalues E^{Θ} (real),

$${ℋ}_{{ΘΘ}^{′}} = {\sum }_{{Θ}^{″}} {V}_{{ΘΘ}^{″}} {E}^{{Θ}^{″}} {V}_{{Θ}^{′} {Θ}^{″}} : \\ {\sum }_{{Θ}^{″}} {V}_{{ΘΘ}^{″}} {V}_{{Θ}^{′} {Θ}^{″}} = {δ}_{{ΘΘ}^{′}} , {\sum }_{{Θ}^{″}} {V}_{{Θ}^{″} Θ} {V}_{{Θ}^{″} {Θ}^{′}} = {δ}_{{ΘΘ}^{′}}$$

If desired, one can form the classically and quantumly tractable “eigenstate generator reference state,”

$$\vert {Ω}^{Θ} 〉 ≡ {\sum }_{{Θ}^{′}} {V}_{{Θ}^{′} Θ} \vert {Φ}^{{Θ}^{′}} 〉 ≡ {\hat{V}}^{Θ} \vert \vec{0} 〉$$

Thus providing the following equivalent definitions of the MC-VQE eigenstates,

$$\begin{matrix}\vert {Ψ}^{Θ} 〉 ≡ {\sum }_{{Θ}^{′}} {V}_{{Θ}^{′} Θ} \vert {Γ}^{{Θ}^{′}} 〉 \\ = {\sum }_{{Θ}^{′}} {V}_{{Θ}^{′} Θ} \hat{U} ( \{ {θ}_{g} \} ) \vert {Φ}^{{Θ}^{′}} 〉 = {\sum }_{{Θ}^{′}} {V}_{{Θ}^{′} Θ} \hat{U} ( \{ {θ}_{g} \} ) {\hat{W}}^{{Θ}^{′}} \vert \vec{0} 〉 \\ = \hat{U} ( \{ {θ}_{g} \} ) \vert {Ω}^{Θ} 〉 = \hat{U} ( \{ {θ}_{g} \} ) {\hat{V}}^{Θ} \vert \vec{0} 〉\end{matrix}$$

I.e., in the last two expressions, the complete MC-VQE eigenstate can be prepared from a single quantum circuit.

### G. MC-VQE ASCI Pauli Gradient (Hybrid Quantum/Classical)

### 1. Targets

dE^{Θ}/dv_{P}≡Γ̅_{P}^{Θ}—relaxed Pauli density matrix.

### 2. Parameters

δ_{SA-VQE-Hessian}—eigenvalue cutoff for pseudoinversion of SA-VQE Hessian.

### 3. Procedure

Evaluate the unrelaxed Pauli density matrix (real, primary quantum observable, or alternatively classical tractable from existing entangled reference state Pauli density matrix elements),

$${Γ}_{P}^{Θ} ≡ \frac{\partial {E}^{Θ}}{\partial {v}_{P}} = 〈 {Ψ}^{Θ} \vert \frac{\partial \hat{H}}{\partial {v}_{P}} \vert {Ψ}^{Θ} 〉 = 〈 {Ψ}^{Θ} \vert {\hat{Π}}_{P} \vert {Ψ}^{Θ} 〉$$

These Pauli density matrix elements can be evaluated by Pauli observations of a single quantum circuit by using the eigenstate generator reference state circuits. Alternatively, these quantities can be obtained by classically rotating the Paulli density matrix elements from the entangled reference state basis (Λ^{ΘΘ′}) to the MC-VQE eigenstate basis (Γ^{ΘΘ′}) by transforming via V_{Θ′Θ}.

Evaluate the state energy SA-VQE parameter gradient,

$$\frac{\partial {E}^{Θ}}{\partial {θ}_{g}}$$

As before, we can evaluate this quantity by evaluating Pauli density matrix elements over a quantum parameter shift rule stencil (real, primary quantum observables),

$$\begin{matrix}\frac{\partial }{\partial {θ}_{g}} {Γ}_{P}^{Θ} ≡ \frac{\partial }{\partial {θ}_{g}} 〈 {Ψ}^{Θ} \vert {\hat{Π}}_{P} \vert {Ψ}^{Θ} 〉 \\ = {\sum }_{T} {α}_{T} 〈 {Ψ}^{Θ} ( \{ {θ}_{g} + {ζ}_{T} ; {θ}_{{g}^{′} \neq g} \} ) \vert {\hat{Π}}_{P} \vert {Ψ}^{Θ} ( \{ {θ}_{g} + {ζ}_{T} ; {θ}_{{g}^{′} \neq g} \} ) 〉\end{matrix}$$

which can then be classically contracted with the coefficients of the Pauli strings in the Jordan-Wigner representation of the ASCI Hamiltonian,

$$⇒ \frac{\partial {E}^{Θ}}{\partial {θ}_{g}} = {\sum }_{P} {v}_{P} \frac{\partial }{\partial {θ}_{g}} {Γ}_{P}^{Θ}$$

As before, these Pauli density matrix elements can be evaluated by Pauli observations of a single quantum circuit per T point by using the eigenstate generator reference state circuit. This quantity could technically be evaluated by parameter shift Pauli density matrix elements of entangled reference state quantities (including off-diagonal Θ≠Θ′ contributions) rotated into the MC-VQE eigenbasis by transforming via V_{Θ′Θ}. However, this second pathway seems at first impression to require measurements of more quantum circuits than the approach in terms of eigenstate generator reference states described here. Evaluate the SA-VQE state-averaged energy Hessian,

$$\frac{{\partial }^{2} \overline{E}}{\partial {θ}_{g} \partial {θ}_{{g}^{′}}} = {\sum }_{Θ} {w}_{Θ} \frac{{\partial }^{2}}{\partial {θ}_{g} \partial {θ}_{{g}^{′}}} 〈 {Γ}^{Θ} \vert \hat{H} \vert {Γ}^{Θ} 〉$$

This can be evaluated in terms of Pauli density matrices evaluated over a double parameter shift rule (real, primary quantum observable),

$$\begin{matrix}\frac{{\partial }^{2}}{\partial {θ}_{g} \partial {θ}_{{g}^{′}}} {Λ}_{P}^{Θ} ≡ \frac{{\partial }^{2}}{\partial {θ}_{g} \partial {θ}_{{g}^{′}}} 〈 {Γ}^{Θ} \vert {\hat{Π}}_{P} \vert {Γ}^{Θ} 〉 \\ = {\sum }_{T} {\sum }_{{T}^{′}} {α}_{T} {α}_{{T}^{′}} 〈 {Γ}^{Θ} ( \{ {θ}_{g} + {ξ}_{T} ; {θ}_{{g}^{′}} + {ξ}_{{T}^{′}} ; {θ}_{{g}^{″} \neq g , {g}^{′}} \} ) \\ \vert {\hat{Π}}_{P} \vert {Γ}^{Θ} ( \{ {θ}_{g} + {ξ}_{T} ; {θ}_{{g}^{′}} + {ξ}_{{T}^{′}} ; {θ}_{{g}^{″} \neq g , {g}^{′}} \} ) 〉\end{matrix}$$

which can then be classically contracted with the coefficients of the Pauli strings in the Jordan-Wigner representation of the ASCI Hamiltonian,

$$⇒ \frac{{\partial }^{2} \overline{E}}{\partial {θ}_{g} \partial {θ}_{{g}^{′}}} = {\sum }_{Θ} {w}_{Θ} {\sum }_{P} {v}_{P} \frac{{\partial }^{2}}{\partial {θ}_{g} \partial {θ}_{{g}^{′}}} {Λ}_{P}^{Θ}$$

Classically solve the SA-VQE response equations,

$${\sum }_{{g}^{′}} \frac{{\partial }^{2} \overline{E}}{\partial {θ}_{g} \partial {θ}_{{g}^{′}}} {\tilde{θ}}_{{g}^{′}} = - \frac{\partial {E}^{Θ}}{\partial {θ}_{g}}$$

At present, this is solved by pseudoinversion,

$$\frac{{\partial }^{2} \overline{E}}{\partial {θ}_{g} \partial {θ}_{{g}^{′}}} = {\sum }_{{g}^{″}} {U}_{{gg}^{″}} {h}_{{g}^{″}} {U}_{{g}^{′} {g}^{″}} :$$

$${\sum }_{{g}^{″}} {U}_{{gg}^{″}} {U}_{{g}^{′} {g}^{″}} = {δ}_{{gg}^{′}} , {\sum }_{{g}^{″}} {U}_{{g}^{″} g} {U}_{{g}^{″} {g}^{′}} = {δ}_{{gg}^{′}}$$

with the Moore-Penrose pseudoinverse,

$${\tilde{θ}}_{g} = - {\sum }_{{g}^{′}} {\sum }_{{g}^{″}} {U}_{{gg}^{″}} {h}_{{{g}^{″}}^{\\}}^{- 1} {U}_{{g}^{′} {g}^{″}} \frac{\partial {E}^{Θ}}{\partial {θ}_{{g}^{′}}} :$$

$${h}_{{g}^{″}} > {δ}_{SA - VQE - Hessian}$$

with user-specified eigenvalue cutoff δ_{SA-VQE-Hessian}.

Compute the response contribution to the Pauli density matrix,

$$\begin{matrix}{\tilde{Γ}}_{P}^{⊖} = {\sum }_{g} {\tilde{θ}}_{g} \frac{{\partial }^{2} \overline{E}}{\partial {θ}_{g} \partial {ν}_{G}} \\ = {\sum }_{g} {\tilde{θ}}_{g} {\sum }_{{⊖}^{′}} {ω}_{{⊖}^{′}} \frac{{\partial }^{2}}{\partial {θ}_{g} \partial {ν}_{G}} 〈 {Γ}^{{⊖}^{′}} \vert \hat{H} \vert {Γ}^{{⊖}^{′}} 〉 \\ = {\sum }_{g} {\tilde{θ}}_{g} {\sum }_{{⊖}^{′}} {ω}_{{⊖}^{′}} \frac{{\partial }^{2}}{\partial {θ}_{g}} 〈 {Γ}^{{⊖}^{′}} \vert {\hat{π}}_{P} \vert {Γ}^{{⊖}^{′}} 〉 \\ = {\sum }_{g} {\tilde{θ}}_{g} {\sum }_{{⊖}^{′}} {ω}_{{⊖}^{′}} \frac{{\partial }^{2}}{\partial {θ}_{g}} {Λ}_{P}^{{⊖}^{′}} \\\end{matrix}$$

The new quantity here is the parameter derivative of the entangled reference state Pauli density matrix element, which can be evaluated by the parameter shift rule (real, primary quantum observable),

$$\frac{\partial }{\partial {θ}_{g}} {Λ}_{P}^{Θ} = \frac{\partial }{\partial {θ}_{g}} 〈 {Γ}^{Θ} \vert {\hat{H}}_{P} \vert {Γ}^{Θ} 〉 = {\sum }_{T} {α}_{T} 〈 {Γ}^{Θ} ( \{ {θ}_{g} + {ζ}_{T} ; {θ}_{{g}^{′} \neq g} \} ) \vert {\hat{Π}}_{P} \vert {Γ}^{Θ} ( \{ {θ}_{g} + {ζ}_{T} ; {θ}_{{g}^{′} \neq g} \} ) 〉$$

The relaxed Pauli density matrix is now classically formed as,

$${\overline{Γ}}_{P}^{Θ} ≡ {Γ}_{P}^{Θ} + {\tilde{Γ}}_{P}^{Θ}$$

### H. MC-VQE ASCI Second-Quantized Gradient (Classical)

### 1. Targets

dE^{Θ}/dhₜᵤ≡γ̅ₜᵤ^{Θ}—relaxed one-particle matrix (1PDM) in active space.
dE^{Θ}/d(tu/vw)≡Γ̅_{tuvw}^{Θ}—relaxed two-particle matrix (2PDM) in active space.

### 2. Procedure

Form the relaxed 1PDM (spin-summed) in the active space (real, square, SPSD),

$${\overline{γ}}_{t u}^{Θ} = {\sum }_{P} \frac{\partial {υ}_{P}}{\partial {h}_{t u}} {\overline{Γ}}_{P}^{Θ}$$

Form the relaxed 2PDM (spin-summed) in the active space (real, same structure as ERIs),

$${\overline{Γ}}_{tu υ ω}^{Θ} = {\sum }_{P} \frac{\partial {υ}_{P}}{\partial ( tu \vert υ ω )} {\overline{Γ}}_{P}^{Θ}$$

Both of these quantities can be formed by differentiation of the expressions for vₚ, which are linear in hₜᵤ and (tu|vw).

### I. Integral Derivative Contributions (Classical)

### 1. Targets

Part of dE^{Θ}/dξ—all parts of gradient of state energy with respect to nuclear positions except those stemming from FOMO-RHF orbital response.

### 2. Parameters

Cutoff values for molecular integral derivatives

### 3. Procedure

Form the relaxed active space 2-body cumulant (real, same structure as ERIs),

$${\overline{λ}}_{tu υω}^{Θ} ≡ {\overline{Γ}}_{tu υω}^{Θ} - \frac{1}{2} {\overline{γ}}_{t u}^{Θ} {\overline{γ}}_{υω}^{Θ} + \frac{1}{4} {\overline{γ}}_{t υ}^{Θ} {\overline{γ}}_{u ω}^{Θ}$$

Form the relaxed spin-summed 2-body cumulant ERI contribution to the gradient,

$$\frac{\partial {E}^{Θ}}{\partial ξ} ← {\sum }_{tu υω} {\overline{λ}}_{tu υω}^{Θ} {\sum }_{μ ν λ σ} {C}_{μ t} {{C}_{ν u} ( μ ν \vert λ σ )}^{ξ} {C}_{λ υ} {C}_{σω}$$

Form the relaxed spin-summed 1PDM Coulomb wedge ERI contribution to the gradient,

$$\frac{\partial {E}^{Θ}}{\partial ξ} ← \frac{1}{2} {\sum }_{μ ν λ σ} {{\overline{D}}_{μ ν}^{Θ} ( μ ν \vert λ σ )}^{ξ} {\overline{D}}_{λ σ}^{Θ}$$

Form the relaxed spin-summed 1PDM exchange wedge ERI contribution to the gradient,

$$\frac{\partial {E}^{Θ}}{\partial ξ} ← - \frac{1}{4} {\sum }_{μ ν λ σ} {{\overline{D}}_{μ ν}^{Θ} ( μ λ \vert v σ )}^{ξ} {\overline{D}}_{λ σ}^{Θ}$$

Form the relaxed spin-summed 1PDM kinetic integral contribution to the gradient,

$$\frac{\partial {E}^{Θ}}{\partial ξ} ← {\sum }_{μ ν} {{\overline{D}}_{μ ν}^{Θ} ( μ \vert - {∇}_{1}^{2} / 2 \vert ν )}^{ξ}$$

Form the relaxed spin-summed 1PDM nuclear potential integral contribution to the gradient,

$$\frac{\partial {E}^{Θ}}{\partial ξ} ← {\sum }_{μ ν} {{\overline{D}}_{μ ν}^{Θ} ( μ \vert - {\sum }_{A} {Z}_{A} / {r}_{1 A} \vert v )}^{ξ}$$

Form the nuclear repulsion energy contribution to the gradient,

$$\frac{\partial {E}^{Θ}}{\partial ξ} ← \frac{\partial {E}_{N u c}}{\partial ξ}$$

Above the relaxed spin-summed 1PDM is (real, square, SPSD),² ² Note that as defined, this quantity is relaxed with respect to any parameters in the active space CI procedure, such as SA-VQE parameters, but is not relaxed with respect to the FOMO-RHF orbital parameters.

$${\overline{D}}_{μ ν}^{Θ} ≡ {\sum }_{i} 2 {C}_{μ i} {C}_{ν i} + {\sum }_{t u} {C}_{μ t} {\overline{γ}}_{t u}^{Θ} {C}_{ν u}$$

Note in the above that the state energy can be evaluated as,

$${E}^{Θ} ≡ {E}_{N u c} + {\sum }_{p q} {\overline{γ}}_{p q}^{θ} ( p \vert - {∇}_{1}^{2} / 2 - {\sum }_{A} {Z}_{A} / {r}_{1 A} \vert q ) + {\sum }_{p q r s} {\overline{Γ}}_{p q r s}^{Θ} ( p q \vert rs ) = {E}_{N u c} + {\sum }_{p q} {\overline{γ}}_{p q}^{θ} ( p \vert - {∇}_{1}^{2} / 2 - {\sum }_{A} {Z}_{A} / {r}_{1 A} \vert q ) + \frac{1}{2} {\sum }_{p q r s} {\overline{γ}}_{p q}^{Θ} {\overline{γ}}_{r s}^{Θ} ( p q \vert r s ) - \frac{1}{4} {\sum }_{p q r s} {\overline{γ}}_{p q}^{Θ} {\overline{γ}}_{r s}^{Θ} ( p r \vert qs ) + {\sum }_{t u v w} {\overline{λ}}_{t u v w}^{Θ} ( t u \vert v w )$$

To this point we have added the contributions to the gradient that come from the gradients of the AO-basis Hamiltonian integrals E_{Nuc}^{ξ}, (μ|−□₁²/2/ν)^{ξ}, (μ|−Σ_{A}Z_{A}/r_{1A}/ν)^{ξ}, and (μν/λσ)^{ξ}. We have not yet added the contributions to the gradient from the orbital orthogonality constraint (involving (μ|ν)^{ξ}) or from the FOMO-RHF orbital response (which ultimately will provide additional contributions to all integral derivatives).

Similar terms arise from the overlap integral derivatives via the orbital Lagrangian and from the orbital response contributions involving CP-FOMO-RHF equations. These can be dealt with by substitution of the relaxed active space 1PDM and 2PDM from MC-VQE into a standard FOMO-CASCI gradient code.

### III. Background Electronic Structure Theory

### A. First Quantization

### 1. Molecular Geometry

We are given the molecular geometry,

{x_{A},y_{A},z_{A},Z_{A},}≡{\vec{r}_{A},Z_{A}}

Here \vec{r}_{A} is the Cartesian coordinate of the position of nucleus A and Z_{A} is the charge of nucleus A. There are N_{A} atoms.

Affiliated with this molecular geometry are a number of electrons. Each electron i is characterized by a spatial coordinate \vec{r}ᵢ and a spin coordinate sᵢ. The joint electronic coordinate is \vec{x}ᵢ≡<\vec{r}ᵢ, sᵢ>.

### 2. Hamiltonian

The electronic Hamiltonian for the system is,

$$\hat{H} ≡ {\sum }_{i} - \frac{1}{2} {∇}_{i}^{2} + {\sum }_{A > B} \frac{{Z}_{A} {Z}_{B}}{{r}_{A B}} + {\sum }_{i A} - \frac{{Z}_{A}}{{r}_{i A}} + {\sum }_{i > j} \frac{1}{{r}_{ij}}$$

Here i and j represent electrons, while A and B represent nuclei. These terms represent the electronic kinetic energy, the nuclear-nuclear repulsion energy (a scalar), the nuclear-electron attraction potential (a one-body operator) and the electron-electron repulsion potential (a two-body operator).

### 3. The Electronic Schrodinger Equation

The task at hand is to determine the electronic wavefunction (also called the “eigenfunction” or “adiabatic wavefunction”), expressed in the electronic position basis as,

$$\vert {Ψ}^{Θ} 〉 ≡ {Ψ}^{Θ} ( … , {\vec{x}}_{i} , … , {\vec{x}}_{j} , … )$$

The label Θ indicates the electronic level, e.g., the electronic ground or excited state.

This is accomplished by solving the time-independent electronic Schrödinger equation,

$$\hat{H} \vert {Ψ}^{Θ} 〉 = {E}^{Θ} \vert {Ψ}^{Θ} 〉$$

Subject to the constraints of orthogonality,

$$〈 {Ψ}^{Θ} \vert {Ψ}^{{Θ}^{′}} 〉 = {δ}_{Θ Θ} ,$$

simultaneous diagonalization of the α-electron counting operator,

$${\hat{N}}_{α} \vert {Ψ}^{Θ} 〉 = {N}_{α} \vert {Ψ}^{Θ} 〉$$

the β-electron counting operator,

$${\hat{N}}_{β} \vert {Ψ}^{Θ} 〉 = {N}_{β} \vert {Ψ}^{Θ} 〉$$

and the spin-squared operator,

$${\hat{S}}^{2} \vert {Ψ}^{Θ} 〉 = S ( S + 1 ) \vert {Ψ}^{Θ} 〉$$

and antisymmetry,

$${Ψ}^{Θ} ( … , {\vec{x}}_{i} , … , {\vec{x}}_{j} , … ) = - {Ψ}^{Θ} ( … , {\vec{x}}_{j} , … , {\vec{x}}_{i} , … )$$

The operators \hat{N}_{α}, \hat{N}_{β}, and Ŝ² are best defined in the second quantized picture below.

### B. Second Quantization

### 1. Spatial Atomic Orbital Basis Set

To make further progress, we are also given the atomic orbital basis set for the molecule,

{ϕ_{μ}(\vec{r}₁;{\vec{r}_{A}})}

Here, each ϕ_{μ}(\vec{r}₁) is a square integrable function in [symbol] ₂( [symbol] ³). The notation above indicates that the characteristics of the atomic orbital basis set may depend parametrically on the nuclear coordinates {\vec{r}_{A}}. E.g., one extremely common case is a basis of atom-centered contracted Gaussian type orbitals,

$${ϕ}_{μ} ( {\vec{r}}_{1} ; {\vec{r}}_{A} ) ≡ {x}_{1 A}^{{l}_{μ}} {y}_{1 A}^{{m}_{μ}} {z}_{1 A}^{{n}_{μ}} {\sum }_{K} {β}_{K}^{μ} exp ( - {α}_{K}^{μ} {r}_{1 A}^{2} )$$

Here the Gaussian exponents {α_{K}^{μ}} and contraction coefficients {β_{K}^{μ}} are atom-specific parameters that are tabulated for each atom type according to a basis set name such as “STO-3G,” “6-31G**,” or “cc-pVDZ.” These parameters are invariant with respect to the nuclear positions. The Gaussian basis defined above uses the “Cartesian” convention with Cartesian monomials of the form x_{1A}^{l}^{_{μ}}y_{1A}^{m}^{_{μ}}z_{1A}ⁿ^{_{μ}} used to provide orbital angular momentum to each Gaussian. One often also encounters the “spherical” convention where specific linear combinations of Cartesian Gaussians are used to provide shells of Gaussians which are pure eigenstates of \hat{L}² for each atom (note the Cartesian Gaussians are not pure eigenstates of \hat{L}² for each atom). Note that for up to and including p angular momentum. Cartesian and spherical Gaussian basis sets have identical span. However, above p angular momentum, the spherical Gaussian basis set will be slightly smaller than the corresponding Cartesian Gaussian basis set due to the removal of low-L² contaminants in the former. E.g., a d shell in Cartesian will have the 6 Cartesian orbitals xx, xy, xz, yy, yz, and zz, while there will only be 5 corresponding spherical orbitals xy, xz, yz, x²−y² and 2z²−x²−y². The specifics of Cartesian/spherical Gaussian basis sets and the particular selection of Gaussian basis parameters are handled by logic in the classical electronic structure codes. There are N_{μ}∝N_{A} atomic basis functions.

WLOG, we take the atomic orbitals to be wholly real here and throughout.

### 2. Spatial Molecular Orbital Basis Set

The atomic orbitals above are spatially overlapping, i.e.,

$$( {ϕ}_{μ} \vert {ϕ}_{ν} ) ≡ {S}_{μ ν} ≡ {\int }_{{ℝ}^{3}} {d}^{3} {r}_{1} {ϕ}_{μ} ( {\vec{r}}_{1} ) {ϕ}_{ν} ( {\vec{r}}_{1} ) \neq {δ}_{μ ν}$$

To make the forthcoming derivations easier, we introduce the orthogonal spatial molecular orbitals,

$${ψ}_{p} ( {\vec{r}}_{1} ) ≡ {\sum }_{μ q} {ϕ}_{μ} ( {\vec{r}}_{1} ) {X}_{μ q} {U}_{q p}$$

Here the “orthogonalization matrix” X_{μp} is defined such that,

$${\sum }_{μ ν} {X}_{μ p} {S}_{μ ν} {X}_{ν q} = {δ}_{p q}$$

Note that this implies that the molecular orbitals are orthonormal,

$$( {ψ}_{p} \vert {ψ}_{q} ) ≡ {\int }_{{ℝ}^{3}} {d}^{3} {r}_{1} {ψ}_{p} ( {\vec{r}}_{1} ) {ψ}_{q} ( {\vec{r}}_{1} ) = {δ}_{p q}$$

Also note the traditional electronic structure notation of ( . . . ) to denote integrals over spatial orbitals in [symbol] ³.

### 3. Spin Molecular Orbital Basis Set

Here and throughout, we adopt the “restricted” spin orbital formulation, wherein every spatial orbital ψₚ(\vec{r}₁) generates two spin orbitals, i.e., an α spin-orbital χₚ(\vec{x}₁),

χₚ(\vec{x}₁)≡ψₚ(\vec{r}₁)α(s₁)

and a β spin-orbital χ_{p̅}(\vec{x}₁),

χ_{p̅}(\vec{x}₁)≡ψₚ(\vec{r}₁)β(s₁)

Here the electron spin wavefunctions α(s₁) and β(s₁) are logical entities defined such that integration over the spin coordinate yields,

$$〈 α \vert α 〉 = 〈 β \vert β 〉 = 1 , 〈 α \vert β 〉 = 0$$

Note that there also exists the “unrestricted” spin orbital formulation, where the spatial parts of each α and β orbital may be different. The derivation pathways and resultant theories for restricted and unrestricted electronic structure methods branch (i.e., they yield fundamentally different theories). One particular problem with unrestricted theories is that they often lead to ansatz states which numerically break the Ŝ² quantum number symmetry until the full configuration interaction limit is achieved.

### 4. The Fock Space

The Fock space for this set of M spatial orbitals has 2^{2M} elements represented by occupation number vectors (“dets”| [symbol] ) labeled |M̅ . . . B̅ĀM . . . BA [symbol] (the “adjoined” ordering). The Fock space dets are an orthonormal basis if the underlying spin-orbitals are orthonormal, i.e., [symbol] \vec{I}| [symbol] =δ_{\vec{I}\vec{J}}, which we assume here and throughout.

We can manipulate the Fock space by means of composition operators \hat{p}^{†} (creation) and \hat{q} (annihilation). These act (in either a spin-orbital picture or within the α or β spin manifolds) as,

$${\hat{p}}^{†} \vert … 0 … 〉 = {( - 1 )}^{{\sum }_{s = 0}^{p - 1} {f}_{s}} \vert … 1 … 〉 \\ {\hat{p}}^{†} \vert … 1 … 〉 = 0 \\ \hat{p} \vert … 1 … 〉 = {( - 1 )}^{{\sum }_{s = 0}^{p - 1} {f}_{s}} \vert … 0 … 〉 \\ \hat{p} \vert {f}_{m - 1} … 0 … 〉 = 0$$

where fₛ is the “Jordan-Wigner factor” that is one if orbital s is occupied, zero otherwise. So the “Jordan-Wigner string” (−1)Σₛ₌₀^{p-1}fₛ computes parity of the number of occupied orbitals in the left-side ellipsis.

Second quantization can be succinctly written via the anticommutation relations,

[\hat{p},\hat{q}]+=0,[\hat{p}^{†},\hat{q}^{†}]+0,[\hat{p},\hat{q}^{†}]+=δ_{pq}

Using these relations, the Jordan-Wigner strings are usually not encountered in the day-to-day manipulations of classical electronic structure theory-instead we resolve classically-tractable matrix elements in terms of the anticommutation relations, Wick's theorem, Feynman diagrams, or other algebraic techniques that do not explicitly depend on an absolute set of Jordan-Wigner strings.

### 5. Operators in the Fock Space

The spin-restricted Hamiltonian is,

$$\hat{H} = {E}_{Nuc} + {\sum }_{pq} ( p \vert \hat{h} \vert q ) ( {p}^{+} q + {\overline{p}}^{+} \overline{q} ) + \frac{1}{2} {\sum }_{pqrs} ( pq \vert rs ) [ 2 {\overline{p}}^{+} \overline{q} {r}^{+} s + {p}^{+} {r}^{+} sq + {\overline{p}}^{+} {\overline{r}}^{+} \overline{s} \overline{q} ] \qquad ( 2 )$$

This operator has eigenvalues E^{Θ}.

The α number operator is,

$${\hat{N}}_{α} ≡ {\sum }_{p} {p}^{†} p = ( M / 2 ) \hat{I} - {\sum }_{p} {\hat{Z}}_{p} / 2$$

The eigenvalues of the α number operator are N_{α}∈[0, 1, . . . M] with degeneracy

$$( \begin{matrix}M \\ {N}_{α}\end{matrix} ) {2}^{M} .$$

The dets are eigenfunctions of the α number operator, with eigenvalues given by the α population count,

$${\hat{N}}_{α} \vert \vec{I} 〉 = popcount ( {\vec{I}}_{α} ) \vert \vec{I} 〉 = {N}_{α} \vert \vec{I} 〉$$

The β number operator is,

$${\hat{N}}_{β} ≡ {\sum }_{p} {\overline{p}}^{†} \overline{p} = ( M / 2 ) \hat{I} - {\sum }_{\overline{p}} {\hat{Z}}_{\overline{p}} / 2$$

The eigenvalues of the β number operator are N_{B}∈[0, 1, . . . M] with degeneracy

$$( \begin{matrix}M \\ {N}_{β}\end{matrix} ) {2}^{M} .$$

The dets are eigenfunctions of the β number operator, with eigenvalues given by the β population count,

$${\hat{N}}_{β} \vert \vec{I} 〉 = popcount ( {\vec{I}}_{β} ) \vert \vec{I} 〉 = {N}_{β} \vert \vec{I} 〉$$

The total (τ) number operator is,

$${\hat{N}}_{τ} ≡ {\hat{N}}_{α} + {\hat{N}}_{β} = ( M ) \hat{I} - {\sum }_{p} {\hat{Z}}_{p} / 2 - {\sum }_{\overline{p}} {\hat{Z}}_{\overline{p}} / 2$$

The eigenvalues of the total number operator are N_{τ}∈[0, 1, . . . 2M] with degeneracy

$$( \begin{matrix}2 M \\ {N}_{τ}\end{matrix} ) .$$

The dets are eigenfunctions of the total number operator, with eigenvalues given by the total population count,

$${\hat{N}}_{τ} \vert \vec{I} 〉 = popcount ( \vec{I} ) \vert \vec{I} 〉 = {N}_{τ} \vert \vec{I} 〉$$

The net high-spin (Δ) number operator is,

$${\hat{N}}_{Δ} ≡ {\hat{N}}_{α} - {\hat{N}}_{β} = - {\sum }_{p} {\hat{Z}}_{p} / 2 + {\sum }_{\overline{p}} {\hat{Z}}_{\overline{p}} / 2$$

The eigenvalues of the net high-spin number operator are N_{Δ}∈[−M, −M+1, . . . , 0, . . . , M−1, M] with degeneracy of

$$( \begin{matrix}2 M \\ \vert M - {N}_{τ} \vert\end{matrix} ) .$$

The dets are eigenfunctions of the net high-spin number operator, with eigenvalues given by the difference population count,

$${\hat{N}}_{δ} \vert \vec{I} 〉 = [ popcount ( {\vec{I}}_{α} ) - popcount ( {\vec{I}}_{β} ) ] \vert \vec{I} 〉 = {N}_{δ} \vert \vec{I} 〉$$

One often encounters the logically-equivalent net \hat{z} spin-projection operator,

$${\hat{S}}_{z} ≡ \frac{1}{2} {\hat{N}}_{Δ} = - {\sum }_{p} {\hat{Z}}_{p} / 4 + {\sum }_{\overline{p}} {\hat{Z}}_{\overline{p}} / 4$$

The characteristics of this operator are the same as that of the net high-spin number operator, except that the eigenvalues are the half-integers S_{z}∈[−M/2, (−M +1)/2, . . . , 0, . . . , (M−1)/2, M/2].

The total spin squared operator is,

$${\hat{S}}^{2} = {\hat{S}}_{-} {\hat{S}}_{+} + {\hat{S}}_{z} + {\hat{S}}_{z}^{2}$$

$$where ,$$

$${\hat{S}}_{-} ≡ {\sum }_{p} {\overline{p}}^{†} p$$

$$and ,$$

$${\hat{S}}_{+} ≡ {\sum }_{p} {p}^{†} \overline{p}$$

Let us consider,

$${\hat{S}}_{-} {\hat{S}}_{+} = {\sum }_{p q} {\overline{p}}^{†} p {q}^{†} \overline{q} = {\sum }_{p q} p {q}^{†} {\overline{p}}^{†} \overline{q}$$

### 6. Molecular Integrals in Spatial Orbitals

In the above expressions, we encounter the following spatial orbital molecular integrals:

### Overlap:

$$( p \vert q ) ≡ d {\vec{r}}_{1} {ψ}_{p}^{*} ( {\vec{r}}_{1} ) {ψ}_{q} ( {\vec{r}}_{1} )$$

One body (kinetic and external potential),

$$( p \vert \hat{h} \vert q ) ≡ d {\vec{r}}_{1} {ψ}_{p}^{*} ( {\vec{r}}_{1} ) [ - \frac{1}{2} {∇}_{1}^{2} - {\sum }_{A} \frac{{Z}_{A}}{{r}_{1 A}} ] {ψ}_{q} ( {\vec{r}}_{1} )$$

Two body (electron repulsion),

$$( pq \vert rs ) ≡ \int d {\vec{r}}_{1} d {\vec{r}}_{2} {ψ}_{p}^{*} ( {\vec{r}}_{1} ) {ψ}_{q} ( {\vec{r}}_{1} ) \frac{1}{{r}_{12}} {ψ}_{r}^{*} ( {\vec{r}}_{2} ) {ψ}_{s} ( {\vec{r}}_{2} )$$

Occasionally other types of molecular integrals are encountered, e.g., the dipole integrals,

$$( p \vert \hat{x} \vert q ) ≡ d {\vec{r}}_{1} {ψ}_{p}^{*} ( {\vec{r}}_{1} ) [ {x}_{1} - {x}_{c} ] {ψ}_{q} ( {\vec{r}}_{1} )$$

where x_{c} is a user-defined origin, and the dipole integrals are understood to be defined for x, y, and z. For completeness, we also define the nuclear repulsion energy (a scalar),

$${E}_{N u c} ≡ {\sum }_{A > B} \frac{{Z}_{A} {Z}_{B}}{{r}_{A B}}$$

These objects are the key outputs from the classical electronic structure code. In practice, these integrals are evaluated in the spatial orbital basis (e.g., Gaussians) and then transformed to the molecular orbital basis via classical linear algebra operations.

### C. Configuration Interaction

### 1. Full Configuration Interaction

In configuration interaction (CI) methods, we construct the electronic wavefunctions as linear combinations of Fock space determinants,

$$\vert {Ψ}^{Θ} 〉 ≡ {C}_{\vec{I}}^{Θ} \vert \vec{I} 〉$$

Here C_{\vec{I}}^{Θ} are referred to as the CI amplitudes. All trial states of this form automatically satisfy the constraint of antisymmetry, due to the antisymmetry property of the underlying determinant. Additionally, the constraint of wavefunction orthonormality is now lifted to the linear algebraic constraint of orthonormality of the CI amplitudes,

$${\sum }_{\vec{I}} {C}_{\vec{I}}^{Θ} {C}_{\vec{I}}^{{Θ}^{′}} = {δ}_{{ΘΘ}^{′}}$$

In this basis the electronic Schrodiger equation is written,

$${\sum }_{\vec{J}} 〈 \vec{I} \vert \hat{H} \vert \vec{J} 〉 {C}_{\vec{J}}^{Θ} = {C}_{\vec{I}}^{Θ} {E}^{Θ}$$

while the simultaneous diagonalization of the quantum number operators are written,

$$\begin{matrix}{\sum }_{\vec{J}} 〈 \vec{I} \vert \hat{{N}_{α}} \vert \vec{J} 〉 {C}_{\vec{J}}^{Θ} = {C}_{\vec{I}}^{Θ} {N}_{α}^{Θ} \\ {\sum }_{\vec{J}} 〈 \vec{I} \vert \hat{{N}_{β}} \vert \vec{J} 〉 {C}_{\vec{J}}^{Θ} = {C}_{\vec{I}}^{Θ} {N}_{β}^{Θ} \\ {\sum }_{\vec{J}} 〈 \vec{I} \vert {\hat{S}}^{2} \vert \vec{J} 〉 {C}_{\vec{J}}^{Θ} = {C}_{\vec{I}}^{Θ} {S}^{Θ} ( {S}^{Θ} + 1 )\end{matrix}$$

These configuration interaction (CI) equations are entirely equivalent to the electronic Schrödinger equation in spatial coordinates, within the finite span of the atomic orbital basis set. A solution of the CI equations within a given atomic orbital basis set without additional constraints/approximations is known as full CI (FCI). An FCI solution within a hypothetical complete atomic orbital basis set is known as complete CI.

### 2. Active Space Configuration Interaction

Active space configuration interaction (ASCI) methods divide the spatial molecular orbitals into three disjoint subsets:

Closed (i, j, k, l, . . . ),

$${ψ}_{i} ( {\vec{r}}_{1} ) ≡ {\sum }_{μ} {C}_{μ i} {ϕ}_{μ} ( {\vec{r}}_{1} )$$

Active (t, u, v, w, . . . ),

$${ψ}_{t} ( {\vec{r}}_{1} ) ≡ {\sum }_{μ} {C}_{μ t} {ϕ}_{μ} ( {\vec{r}}_{1} )$$

Virtual (a, b, c, d, . . . ),

$${ψ}_{a} ( {\vec{r}}_{1} ) ≡ {\sum }_{μ} {C}_{μ a} {ϕ}_{μ} ( {\vec{r}}_{1} )$$

ASCI methods assert that the closed orbitals are doubly occupied,

$${i}^{†} i \vert {Ψ}^{Θ} 〉 = 1 \vert {Ψ}^{Θ} 〉 , {\overline{i}}^{†} \overline{i} \vert {Ψ}^{Θ} 〉 = 1 \vert {Ψ}^{Θ} 〉 , ∀ i$$

and the virtual orbitals are wholly unoccupied,

$${a}^{†} a \vert {Ψ}^{Θ} 〉 = 0 \vert {Ψ}^{Θ} 〉 , {\overline{a}}^{†} \overline{a} \vert {Ψ}^{Θ} 〉 = 0 \vert {Ψ}^{Θ} 〉 , ∀ a$$

This is equivalent to a picture in which the CI amplitudes are asserted to be sparse, with nonzero amplitudes only present for determinants with occupation number 1 in the closed α and β orbitals, and occupation number 0 in the virtual α and β orbitals.

ASCI methods may be viewed as an approximate ansatz for the FCI wavefunction of the full system. ASCI methods are may also be viewed as an embedding scheme where FCI is solved in the smaller space of active orbitals, for a smaller number of α and β electrons, with a (classically tractable) one-body embedding potential representing the α and β electrons in the closed orbitals at the level of Hartree-Fock theory. The active space Hamiltonian is,

$$\hat{H} = {E}_{E x t} + {\sum }_{t u} ( t \vert \hat{o} \vert u ) ( {t}^{+} u + {\overline{t}}^{+} \overline{u} ) + \frac{1}{2} {\sum }_{t u v w} ( tu \vert vw ) [ 2 {\overline{t}}^{+} \overline{u} {v}^{+} w + {t}^{+} {v}^{+} w u + {\overline{t}}^{+} {\overline{v}}^{+} \overline{w} \overline{u} ] \qquad ( 3 )$$

Here the external energy (the self energy of the external system of Hartree-Fock-level electrons in the closed orbitals) is,

$${E}_{E x t} = {E}_{N u c} + {\sum }_{i} 2 ( i \vert \hat{h} \vert i ) + {\sum }_{i j} 2 ( ii \vert jj ) - {\sum }_{i j} ( ij \vert ij )$$

and the one-body Hamiltonian is,

$$( t \vert \hat{o} \vert u ) ≡ ( t \vert \hat{h} \vert u ) + 2 {\sum }_{i} ( tu \vert ii ) - {\sum }_{i} ( ti \vert ui )$$

The active space \hat{N}_{α}, \hat{N}_{β}, and Ŝ² operators are the same as for the full system, albeit with orbital indices restricted to the active space. The active space quantum numbers N_{α} and N_{β} then refer only to the number of α and β electrons in the active space. The active space S quantum number is the same as in the full space, as the closed and virtual orbital contributions are wholly singlet.

### 3. Effective Approximate Configuration Interaction

It is worth noting that many interesting methods (active space or not) are of the “effective approximate CI” type

$$\vert {Ψ}^{Θ} 〉 ≡ {\sum }_{{I}^{→︀}} {C}_{{I}^{→︀}}^{Θ} [ {θ}_{g}^{Θ} ] \vert \vec{I} 〉$$

Here the notation C_{I}^{Θ}[θ_{g}^{Θ}] means that the CI amplitudes {C_{\vec{I}}^{Θ}} are determined in some effective way from some auxiliary parameters {θ_{g}^{Θ}} that depend of the definition of the effective approximate CI method. The “approximate” label here means that number of free parameters in effective approximate CI methods is generally vastly lower than the exponential number of CI amplitudes (or that the spans of the FCI and effective approximate CI amplitudes might be otherwise definitionally disjoint). This implies that these effective approximate CI method may not (and usually does not) exactly solve the Schrödinger equation to the FCI limit. Moreover, the parameters {θ_{g}^{Θ}} might not even be determined to minimize the state-specific variational energy. However, any effective approximate CI state is still an ansatz state for the Hermitian Hamiltonian in question, and therefore will defintionally produce a variational estimate of the adiabatic state energy. The “effective” label here means that it may be possible for all of the exponential-scaling number of CI amplitudes to be nonzero, e.g., as they might be formed from a tensor product of a polynomial number of auxiliary parameters. “Effective” is also used to amplify that it may be possible to perform all needed manipulations of the effective approximate CI method without ever explicitly forming the CI amplitudes.

Note that a fundamental choice invoked in this work is that “good” effective approximate CI methods are allowed to relax exact diagonalization of the second-quantized Hamiltonian, but must still exactly respect the remaining constraints of orthonormality, antisymmetry, and simultaneous diagonalization of the quantum number operators \hat{N}_{α}, \hat{N}_{β}, and Ŝ².

Note that additional and even more exotic “wavefunction methods” exist in which the concept of bi-orthogonal eigenfunctions of a similarity-transformed Hamiltonian operator is invoked, e.g., in non-Hermitian coupled cluster theory. In this case, the wavefunction picture breaks down somewhat, as separate wavefunctions are used for the left-hand and right-hand wavefunctions. Such methods are definitionally nonvariational, and are best defined by their Lagrangians.

### D. Lagrangian Formalism for Derivative Properties

We will work with a variety of exact (FCI) and approximate (MC-VQE) wavefunction ansatze for {|Ψ^{Θ} [symbol] }. All have the property that the adiabatic energy is the expectation value over the Hamiltonian.

$${E}^{Θ} ≡ 〈 {Ψ}^{Θ} \vert \hat{H} \vert {Ψ}^{Θ} 〉$$

### 1. Derivative Properties

We often require total derivatives of the adiabatic state energy with respect to arbitrary displacements of the Hamiltonian ξ,

$${E}^{Θ , ξ} ≡ \frac{d {E}^{Θ}}{d ξ} = 〈 {Ψ}^{Θ} \vert \frac{\partial \hat{H}}{\partial ξ} \vert {Ψ}^{Θ} 〉 + 〈 {Ψ}^{Θ} \vert \hat{H} \vert \frac{d {Ψ}^{Θ}}{d ξ} 〉 + H . C .$$

The first term is the Hellmann-Feynman contribution, and is the only nonzero contribution if all parameters in |Ψ^{Θ} [symbol] were chosen to make the state energy E^{Θ} stationary (definitionally true for all state-specific variational wavefunctions). However, if the wavefunction contains parameters {Θ_{g}} that were chosen to satisfy other conditions than the stationarity of the state energy, the “wavefunction response” terms will arise,

$${E}^{Θ , ξ} ≡ \frac{d {E}^{Θ}}{d ξ} = 〈 {Ψ}^{Θ} \vert \frac{\partial \hat{H}}{\partial ξ} \vert {Ψ}^{Θ} 〉 + {\sum }_{g} 〈 {Ψ}^{Θ} \vert \hat{H} \vert \frac{\partial {Ψ}^{Θ} ( \{ {θ}_{g} \} )}{\partial {θ}_{g}} 〉 \frac{\partial {θ}_{g}}{\partial ξ} + H . C .$$

At the moment, it seems that we will have to solve the the parameter response ∂θ_{g}/∂ξ separately for each perturbation ξ, which is unacceptable. Fortunately, the Lagrangian formalism helps us avoid this. We define,

$${ℒ}^{Θ} ≡ 〈 {Ψ}^{θ} \vert \hat{H} \vert {Ψ}^{Θ} 〉 + {\underbrace{{\sum }_{{g}^{′}} {\tilde{θ}}_{{g}^{′}} {C}_{{g}^{′}} ( \{ {θ}_{g} \} )}}_{0}$$

Here C_{g}′({θ_{g}})=0 is the g′-th clause of a set of n_{g} equations used to define the parameters {θ_{g}}. {\tilde{θ}_{g}} are Lagrange multipliers. Making the Lagrangian stationary with respect to the Lagrange multipliers specifies the method,

$$\frac{\partial {ℒ}^{Θ}}{\partial {\tilde{θ}}_{{g}^{′}}} = 0 ⇒ {C}_{{g}^{′}} ( \{ {θ}_{g} \} ) = 0$$

Making the Lagrangian stationary with respect to the wavefunction parameters determines the linear response equations,

$$\frac{\partial {ℒ}^{θ}}{\partial {θ}_{g}} = 0 ⇒ {\sum }_{{g}^{′}} \frac{\partial {C}_{{g}^{′}} ( \{ {θ}_{g} \} )}{\partial {θ}_{g}} {\tilde{θ}}_{{g}^{′}} = - \frac{\partial 〈 {Ψ}^{Θ} \vert \hat{H} \vert {Ψ}^{Θ} 〉}{\partial {θ}_{g}}$$

So now the Lagrangian (which always equals the energy) is stationary with respect to perturbations in non-variational wavefunction parameters. Now the desired derivative can be taken,

$$\begin{matrix}{E}^{Θ , ξ} = \frac{d {E}^{Θ}}{d ξ} = \frac{\partial ℒ}{\partial \hat{H}} \frac{d \hat{H}}{d ξ} \\ = 〈 {Ψ}^{Θ} \vert \frac{\partial \hat{H}}{\partial ξ} \vert {Ψ}^{Θ} 〉 + {\sum }_{{g}^{′}} {\tilde{θ}}_{{g}^{′}} \frac{\partial {C}_{{g}^{′}} ( \{ {θ}_{g} \} )}{\partial \hat{H}} \frac{\partial \hat{H}}{\partial ξ} \\ = ( \frac{\partial {E}^{Θ}}{\partial \hat{H}} + {\sum }_{{g}^{′}} {\tilde{θ}}_{{g}^{′}} \frac{\partial {C}_{{g}^{′}} ( \{ {θ}_{g} \} )}{\partial \hat{H}} ) \frac{\partial \hat{H}}{\partial ξ}\end{matrix}$$

The quantities ∂E^{Θ}/∂Ĥ and

$$\frac{\partial {ℒ}^{⊖}}{\partial H} = \frac{d {E}^{⊖}}{d \hat{H}}$$

are sufficiently special that they are named the “unrelaxed” and “relaxed” density matrices, respectively.

Note that the notation ∂/∂Ĥ is meant to imply a sum over the partials of the linear matrix element coefficients in Ĥ.

### 2. Density Matrices

The unrelaxed spin-summed one-particle density matrix (1PDM) is,

$${γ}_{p q}^{Θ} ≡ \frac{\partial {E}^{Θ}}{\partial ( p \vert \hat{h} \vert q )} = 〈 {Ψ}^{Θ} \vert \frac{\partial \hat{H}}{\partial ( p \vert \hat{h} \vert q )} \vert {Ψ}^{Θ} 〉 = 〈 {Ψ}^{Θ} \vert {p}^{+} q \vert {Ψ}^{Θ} 〉 + 〈 {Ψ}^{Θ} \vert {\overline{p}}^{+} \overline{q} \vert {Ψ}^{Θ} 〉$$

The unrelaxed spin-summed two-particle density matrix (2PDM) is,

$${Γ}_{p q r s}^{Θ} ≡ \frac{\partial {E}^{Θ}}{\partial ( pq \vert rs )} = 〈 {Ψ}^{Θ} \vert \frac{\partial \hat{H}}{\partial ( pq \vert rs )} \vert {Ψ}^{Θ} 〉 = 〈 {Ψ}^{Θ} \vert {\overline{p}}^{+} \overline{q} {r}^{+} s \vert {Ψ}^{Θ} 〉 + \frac{1}{2} 〈 {Ψ}^{Θ} \vert {p}^{+} {r}^{+} sq \vert {Ψ}^{Θ} 〉 + \frac{1}{2} 〈 {Ψ}^{Θ} \vert {\overline{p}}^{+} {\overline{r}}^{+} \overline{s q} \vert {Ψ}^{Θ} 〉$$

The relaxed spin-summed one-particle density matrix (1PDM) is,

$${\overline{γ}}_{p q}^{Θ} ≡ \frac{d {E}^{Θ}}{d ( p \vert \hat{h} \vert q )} = {γ}_{p q}^{Θ} + {\overline{γ}}_{p q}^{Θ}$$

The relaxed spin-summed two-particle density matrix (2PDM) is,

$${\overline{Γ}}_{p q r s}^{Θ} ≡ \frac{d {E}^{Θ}}{d ( p q \vert r s )} = {Γ}_{p q r s}^{Θ} + {\tilde{Γ}}_{p q r s}^{Θ}$$

The response spin-summed one-particle density matrix (1PDM) is,

$${\overline{γ}}_{p q}^{Θ} = {\sum }_{{g}^{′}} {\tilde{θ}}_{{g}^{′}} \frac{\partial {C}_{{g}^{′}} ( \{ {θ}_{g} \} )}{\partial ( p \vert \hat{h} \vert q )}$$

The response spin-summed two-particle density matrix (2PDM) is,

$${\tilde{Γ}}_{p q r s}^{Θ} = {\sum }_{{g}^{′}} {\tilde{θ}}_{{g}^{′}} \frac{\partial {C}_{{g}^{′}} ( \{ {θ}_{g} \} )}{\partial ( pq \vert rs )}$$

### IV. Technical Notes: MC-VQE

### A. MC-VQE Ansatz

For MC-VQE, we define the following ansatz for the wavefunction,

$$\vert {Ψ}^{Θ} 〉 ≡ {\sum }_{{Θ}^{′}} {V}_{{ΘΘ}^{′}} \hat{U} ( \{ {θ}_{g} \} ) {\hat{W}}^{{Θ}^{′}} \vert \vec{0} 〉$$

Here |\vec{0} [symbol] is the vacuum qubit state. Ŵ^{Θ} is a unitary operator that is tractable both classically and quantumly, and prepares a “reference” or “guess” state in the correct number block,

$$\vert {Φ}^{Θ} 〉 ≡ {\hat{W}}^{Θ} \vert \vec{0} 〉 :$$

$${\hat{N}}_{α} \vert {Φ}^{Θ} 〉 = {N}_{α} \vert {Φ}^{Θ} 〉$$

$${\hat{N}}_{β} \vert {Φ}^{Θ} 〉 = {N}_{β} \vert {Φ}^{Θ} 〉$$

$${\hat{S}}^{2} \vert {Φ}^{Θ} 〉 = S \vert {Φ}^{Θ} 〉$$

Moreover, we require that the reference states be orthonormal,

$$〈 {Φ}^{Θ} \vert {Φ}^{{Θ}^{′}} 〉 = {δ}_{{ΘΘ}^{′}}$$

The specific choice of reference states is part of the ansatz—we will discuss one expedient choice below. The operator Û ({Θ_{g}}) is the state-averaged VQE (SA-VQE) entangler circuit, with N_{g} parameters {θ_{g}}. We define the entangled reference states as,

$$\vert {Γ}^{Θ} ( \{ {θ}_{g} \} ) 〉 ≡ \hat{U} ( \{ {θ}_{g} \} ) \vert {Φ}^{Θ} 〉 = \hat{U} ( \{ {θ}_{g} \} ) {\hat{W}}^{Θ} \vert \vec{0} 〉$$

We require that the SA-VQE entangler is number pure for any parameter set {θ_{g}},

$$[ {\hat{N}}_{α} , \hat{U} ( \{ {θ}_{g} \} ) ] = 0 , [ {\hat{N}}_{β} , \hat{U} ( \{ {θ}_{g} \} ) ] = 0 , [ {\hat{S}}^{2} , \hat{U} ( \{ {θ}_{g} \} ) ] = 0$$

The parameters are chosen to minimize the state-averaged VQE energy,

$$\overline{E} ( \{ {θ}_{g} \} ) ≡ {\sum }_{Θ} {w}_{Θ} 〈 {Γ}^{Θ} ( \{ {θ}_{g} \} ) \vert \hat{H} \vert {Γ}^{Θ} ( \{ {θ}_{g} \} ) 〉 = {\sum }_{Θ} {w}_{Θ} 〈 {Φ}^{Θ} {\vert}^{{\hat{U}}^{†}} ( \{ {θ}_{g} \} ) \hat{H} \hat{U} ( \{ {θ}_{g} \} ) \vert {Φ}^{Θ} 〉$$

Where the non-increasing weights {w_{Θ}} are parameters of the method. If the weights are chosen identically, i.e., w_{Θ}=1/N_{Θ}, then the state-averaged VQE energy is the average of energy of the VQE states, ⇒Ē=(1/N_{Θ})Σ_{Θ}E^{Θ}. If the weights are not identical, this identity does not hold, due to the forthcoming rotation by V_{ΘΘ′}.

The subspace Hamiltonian is defined as,

$${ℋ}_{{ΘΘ}^{′}} ≡ 〈 {Γ}^{Θ} \vert \hat{H} \vert {Γ}^{{Θ}^{′}} 〉 = 〈 {Φ}^{Θ} {\vert}^{{\hat{U}}^{†}} ( \{ {θ}_{g} \} ) \hat{H} \hat{U} ( \{ {θ}_{g} \} ) \vert {Φ}^{{Θ}^{′}} 〉$$

The diagonal terms [symbol] _{ΘΘ′} are immediately available from quantum circuit Pauli expectation values. The off-diagonal terms can be obtained by forming interfering combinations of reference states,

$$\vert {χ}_{\pm }^{{ΘΘ}^{′}} 〉 ≡ \frac{1}{\sqrt{2}} ( \vert {Φ}^{Θ} 〉 \pm \vert {Φ}^{{Θ}^{′}} 〉 ) ≡ {\hat{X}}_{\pm }^{{ΘΘ}^{′}} \vert \vec{0} 〉$$

where \hat{X}_{±}^{ΘΘ′} is a unitary operator that is tractable both classically and quantumly. With the interfering reference states, we can form,

$${ℋ}_{Θ \neq {Θ}^{′}} = 〈 {χ}_{+}^{{ΘΘ}^{′}} \vert {\hat{U}}^{†} ( \{ {θ}_{g} \} ) \hat{H} \hat{U} ( \{ {θ}_{g} \} ) \vert {χ}_{+}^{{ΘΘ}^{′}} 〉 / 2 - 〈 {χ}_{-}^{{ΘΘ}^{′}} \vert {\hat{U}}^{†} ( \{ {θ}_{g} \} ) \hat{H} \hat{U} ( \{ {θ}_{g} \} ) \vert {χ}_{-}^{{ΘΘ}^{′}} 〉 / 2$$

The MC-VQE eigenvectors V_{ΘΘ′} r are determined by eigendecomposing the subspace Hamiltonian,

$${\sum }_{{Θ}^{′}} {ℋ}_{{ΘΘ}^{′}} {V}_{{Θ}^{′} {Θ}^{″}} = {V}_{{ΘΘ}^{″}} {E}^{{Θ}^{″}} {: \sum }_{Θ} {V}_{{ΘΘ}^{′}} {V}_{{ΘΘ}^{″}} = {δ}_{{Θ}^{′} {Θ}^{″}}$$

The MC-VQE eigenstates (adiabats) |Ψ^{Θ} [symbol] can now be written as detailed below:

### B. Summary of MC-VQE Wavefunction Quantities

Reference states,

$$\vert {Φ}^{Θ} 〉 ≡ {\hat{W}}^{Θ} \vert \vec{0} 〉$$

Entangled reference states,

$$\vert {Γ}^{Θ} ( \{ {θ}_{g} \} ) 〉 ≡ \hat{U} ( \{ {θ}_{g} \} ) \vert {Φ}^{Θ} 〉 = \hat{U} ( \{ {θ}_{g} \} ) {\hat{W}}^{Θ} \vert \vec{0} 〉$$

Subspace Hamiltonian eigenstates (i.e., MC-VQE adiabatic ansatz states),

$$\begin{matrix}\vert {Ψ}^{Θ} 〉 ≡ {\sum }_{{Θ}^{′}} {V}_{{ΘΘ}^{′}} \vert {Γ}^{{Θ}^{′}} 〉 = {\sum }_{{Θ}^{′}} {V}_{{ΘΘ}^{′}} \hat{U} ( \{ {θ}_{g} \} ) \vert {Φ}^{{Θ}^{′}} 〉 \\ = {\sum }_{{Θ}^{′}} {V}_{{ΘΘ}^{′}} \hat{U} ( \{ {θ}_{g} \} ) {\hat{W}}^{{Θ}^{′}} \vert \vec{0} 〉\end{matrix}$$

Defining the “eigenstate generator reference states” (classically and quantumly tractable) as,

$$\vert {Ω}^{Θ} 〉 ≡ {\sum }_{{Θ}^{′}} {V}_{{ΘΘ}^{′}} \vert {Φ}^{{Θ}^{′}} 〉 = {\sum }_{{Θ}^{′}} {V}_{{ΘΘ}^{′}} {\hat{W}}^{{Θ}^{′}} \vert \vec{0} 〉$$

The subspace Hamiltonian eigenstates can now be written as,

$$\vert {Ψ}^{Θ} 〉 ≡ \hat{U} ( \{ {θ}_{g} \} ) \vert {Ω}^{Θ} 〉$$

### V. Technical Notes: Specific FOMO-RHF-MC-VQE Ansatz Choices

This section details the specific choices made in this work for portions of the FOMO-RHF-MC-VQE ansatz that are

### A. Orbital Determination: Fractional Occupation Number Restricted Hartree Fock (FOMO-RHF)

The fractional occupation number restricted Hartree Fock (FOMO-RHF) method constrains the molecular orbitals to diagonalize the Fock matrix,

$${f}_{p q} ≡ {h}_{p q} + 2 ( pq \vert rr ) {n}_{r} - ( pr \vert qr ) {n}_{r} = {δ}_{p q} {ϵ}_{p}$$

while also subject to the constraint of orbital orthonormality,

$$( p \vert q ) = {δ}_{p q}$$

and total electron number constraint,

$${\sum }_{r} {n}_{r} = {N}_{F O M O}$$

The fractional orbital occupation number nᵣ∈[0, 1] for each orbital index r is determined by a strictly nonincreasing function in the orbital energy ϵᵣ. Several popular occupation number functions are used, including the Fermi-Dirac cutoff function,

$${n}_{r}^{F e r m i - D i r a c} ≡ \frac{1}{1 + exp [ β ( {ϵ}_{r} - μ ) ]}$$

and the Gaussian smearing cutoff function,

$${n}_{r}^{G a u s s i a n} ≡ \frac{1}{2} erfc [ β ( {ϵ}_{r} - μ ) ]$$

In both of these cases, the constant β is supplied by the user, and may be roughly interpreted as inverse electronic temperature. The wavefunction parameter μ is varied to conserve the total electron number constraint, and may be roughly interpreted as the Fermi energy.

Note that often the user-supplied total electron number constraint is the intuitive choice of N_{FOMO}≡N_{α}=N_{β}, but a nonstandard choice of N_{FOMO} may also be used to give the FOMO-RHF method additional control parameters. Note also that the FOMO procedure is typically performed in an active space of orbitals near the Fermi level, with orbitals below this active space fixed to occupation numbers of nᵣ=1. and orbitals above this active space fixed to occupation numbers of nᵣ=0. This permits the use of high electronic temperature parameters within the active space while still providing RHF-like orbitals in the occupied and virtual spaces. Also note that the occupied/active/virtual divisions for FOMO-RHF are often chosen to be identical to those in subsequent CASCI methods, but this choice is not necessary for correctness of the full FOMO-CASCI method, and the full FOMO-CASCI method permits the use of disjoint active spaces in the FOMO-RHF and CASCI portions of the computation. One typically sees FOMO-RHF orbital determination implemented within the following augmented Roothan-Hall iterative self-consistent procedure:
1. Obtain a guess to the initial orbitals C_{μp} and occupation numbers nₚ (e.g., through superposition of atomic densities)
2. Form the density matrix D_{μν}≡ΣᵣnᵣC_{μr}C_{νr}.
3. Build the Fock matrix F_{μν}≡H_{μν}+2(μν|λσ)D_{λσ}−(μλ|νσ)D_{λσ}.
4. (DIIS or other convergence acceleration schemes on the Fock matrix may be applied at this point).
5. Diagonalize the Fock matrix, i.e., by solving F_{μν}C_{νr}=S_{μν}C_{νr}ϵᵣ:C_{μr}S_{μν}C_{νs}=δᵣₛ to obtain the updated orbital coefficients C_{μr} and orbital eigenvalues ϵᵣ.
6. Solve for the value of μ such that the total electron constraint Σᵣ nᵣ(ϵᵣ; μ)=N_{FOMO} is met for the current orbital eigenvalues ϵᵣ. This involves solving a 1D continuous nonlinear equation, usually with simple and unique root structure. This can be efficiently solved by bisection or many other root finding methods.
7. Return to Step 2 and iterate until convergence is obtained.

### B. Reference State Determination: Configuration State Functions

We now need to define a pragmatic set of reference states for MC-VQE. Desired characteristics of these states include:
Classical tractability: These states must be efficiently able to be determined and represented by a polynomial number of classical operations.
Quantum tractability: These states should be preparable by simple/short quantum circuits, with all needed quantum circuit gate parameters determined a priori by classical computation.
Orthogonality: For the specific flavor of MC-VQE used here, we require that the reference states be orthonormal. This restriction could be lifted in future work by using a metric-based variant of MC-VQE.
Physical Relevance: Insofar as possible, these states should approximately span the space of the target Hamiltonian eigenfunctions.
Quantum number preservation: These states must all be proper eigenfunctions of \hat{N}_{α}, \hat{N}_{β}, and Ŝ² with the target quantum numbers as eigenvalues.

One pragmatic (but certainly not unique) choice for MC-VQE in fermionic systems is the set of certain configuration state functions (CSFs) in the given qubit orbital basis (i.e., the FOMO-RHF orbital basis). For instance, for singlet states, we will include the RHF CSF.

$$\vert {Φ}_{0} 〉 ≡ {\sum }_{i}^{{N}_{α}} {i}^{†} {\overline{i}}^{†} \vert 〉$$

the set of singlet singly-excited CSFs,

$$\vert {Φ}_{i \to a}^{S} 〉 ≡ \frac{1}{\sqrt{2}} [ {a}^{†} i + {\overline{a}}^{†} \overline{i} ] \vert {Φ}_{0} 〉$$

and the set of diagonal doubly-excited CSFs,

$$\vert {Φ}_{i \to a}^{D} 〉 ≡ {a}^{†} i {\overline{a}}^{†} \overline{i} \vert {Φ}_{0} 〉$$

For a given target number of MC-VQE states, we limit ourselves to a discrete subset of these via a selection procedure. For instance, we may elect to sort the energies of the reference states and then take lowest few sorted reference states to be the working set for MC-VQE. We may also choose the reference states according to character, i.e., by choosing those that maximize the overlap with states from a nearby geometry during dynamics or geometry optimization.

### C. SA-VQE Entangler Circuits: Quantum Number Preserving Circuits

For the SA-VQE entangler circuits, we use circuits composed of localized clusters of quantum number preserving gates (see QC Ware/Covestro patent). As each quantum number preserving gate commutes individually with the \hat{N}_{α}, \hat{N}_{β}, and Ŝ² operators, the SA-VQE entangler circuits commute globally with these operators, and the global SA-VQE entangler circuits are thus quantum number preserving.

1. A method for computing, given a fermionic system depending on one or more continuous system parameters and having a wave function and a set of one or more observables, a first-order derivative of one or more of the observables of the fermionic system with the assistance of a quantum computer, the quantum computer being configured to execute one or more quantum circuits, the quantum circuits depending on one or more continuous quantum circuit parameters, the method comprising:
defining a Lagrangian for each of the one or more observables to be differentiated as the formal definition of that observable;
defining a representation of the wave functions of the fermionic system depending on one or more continuous intermediate computational parameters, with at least one of these intermediate computational parameters being one of the continuous quantum circuit parameters;
modifying the one or more continuous intermediate computational parameters of the wave function of the fermionic system to make one or more continuous nonlinear equations equal to zero, the one or more continuous nonlinear equations including at least one observable of the fermionic system that is determined, at least in part, by the quantum computer executing a quantum circuit;
adding to the Lagrangian, for each of the nonlinear equations, a product of the nonlinear equation times a Lagrange multiplier;
determining the Lagrange multipliers for each set of nonlinear equations to make the part of the Lagrangian corresponding these nonlinear equations stationary with respect to their respective intermediate computational parameters, the determination of the Lagrange multipliers depending on at least one observable that was determined, at least in part, by the quantum computer, the cost of determining the Lagrange multipliers depending on the number of intermediate computational parameters but not on the number of system parameters of the fermionic system with respect to which the first-order derivative are to be computed; and
obtaining at least one first-order derivative of an observable of the fermionic system with respect to any subset of system parameters by determining the partial derivatives of the Lagrangian with respect to these system parameters.

2. The method according to claim 1, wherein the fermionic system further has orbitals, the orbitals being defined in terms of an orbital basis, the orbital basis depending in a differentiable way on one or more system parameters and on one or more orbital parameters, and the wave function of the fermionic system being defined with respect to a Hilbert space over these orbitals, and wherein the continuous intermediate computational parameters include the orbital parameters and wherein modifying the one or more continuous intermediate computational parameters of the wave function of the fermionic system comprises modifying one or more of the orbital parameters to make one or more nonlinear equations equal to zero, the one or more nonlinear equations including observable quantities of the fermionic system.

3. The method according to claim 2, wherein the Hilbert space is the fermionic Fock space over the orbitals and is divided into a closed subspace, an active subspace, and a virtual subspace, whereby the subspaces are nonoverlapping spaces and the closed space and/or virtual space may be empty, and the wave function is restricted to be fully occupied inside the closed space and unoccupied in the virtual space.

4. The method according to claim 1, further comprising:
choosing a mapping between the active space and a subspace of the Hilbert space of the quantum computer, whereby the subspace can be the full Hilbert space of the quantum computer;
determining values of one or more of the observable quantities with the assistance of a quantum computer performing quantum computations involving the preparation of one or more quantum states in the quantum computer corresponding to wave functions of the fermionic system under the chosen mapping by means of quantum circuits, the quantum circuits having one or more continuous circuit parameters;
modifying one or more circuit parameters to make one or more nonlinear equations involving the observable quantities equal to zero; and
adding to the Lagrangian, for each of the nonlinear equations, a product of the nonlinear equation times a Lagrange multiplier.

5. The method according to claim 1, wherein determining the Lagrange multipliers that make the Lagrangian stationary comprises:
determining the Lagrange multipliers for the circuit parameters by solving quantum linear response equations to make the part of the Lagrangian corresponding to the quantum circuit parameters stationary with respect to the quantum circuit parameters, the quantum linear response equations including quantities that were determined with the assistance of the quantum computer; and
determining the Lagrange multipliers for the orbital parameters by solving orbital linear response equations to make the part of the Lagrangian corresponding to the orbital parameters stationary with respect to the orbital parameters, the orbital linear response equations including quantities that were determined with the assistance of the quantum computer.

6. The method according to claim 2, wherein the orbitals are constructed and modified by means of a FOMO-RHF procedure.

7. The method according to claim 1, wherein the values of the quantum circuit parameters are chosen and modified by means of an MC-VQE procedure.

8. The method according claim 1, wherein the intermediate computational parameters include one or more elements of a matrix- and/or tensor-factorized representation of the fermionic Hamiltonian.

9. A method according to claim 1, wherein modifying the one or more continuous intermediate computational parameters comprises modifying orbital parameters and quantum circuit parameters in a way that makes one or more non-linear equation involving both orbital parameters and quantum circuit parameters equal to zero.

10. The method according to claim 1, wherein the fermionic system describes electrons of a chemical system comprising at least one of: a molecule, an atom, a charge, an electron, or an anti-particle.

11. The method according to claim 1, wherein the observable quantity to be differentiated is the energy of a wavefunction, the overlap between two wavefunctions with zero or more of the wavefunctions defined to be frozen under the action of the derivative operator, or a multipole moment or other characteristic of the fermionic density corresponding to a wavefunction.

12. The method according to claim 1, wherein the derivatives are calculated with respect to positions and/or magnitudes of external charges, electric fields, or magnetic fields of or acting on the fermionic system.

13. The method according to claim 1, further comprising steps to perform a simulation of a chemical reaction or properties of such chemical reaction.

14. The method according to claim 1, wherein the determination of the Lagrange multipliers that make the Lagrangian stationary comprises solving one or more equations with exact, approximate, and/or iterative algebraic solvers.

15. (canceled)

16. (canceled)

17. The method according to claim 1, further comprising: transmitting and/or receiving a description of the fermionic system, the observables, the active space, the representations of the observables on the active space, the quantum circuits preparing the states in the quantum computer corresponding to the wave functions of the fermionic system, and/or the resulting first order derivatives to/from the quantum computer or a data processing apparatus system.

18. (canceled)

19. (canceled)

20. A non-transitory computer-readable storage medium comprising instructions which, when executed by a computer, cause the computer to perform a method for computing, given a fermionic system depending on one or more continuous system parameters and having a wave function and a set of one or more observables, a first-order derivative of one or more of the observables of the fermionic system with the assistance of a quantum computer, the quantum computer being configured to execute one or more quantum circuits, the quantum circuits depending on one or more continuous quantum circuit parameters, the method comprising:
defining a Lagrangian for each of the one or more observables to be differentiated as the formal definition of that observable;
defining a representation of the wave functions of the fermionic system depending on one or more continuous intermediate computational parameters, with at least one of these intermediate computational parameters being one of the continuous quantum circuit parameters;
modifying the one or more continuous intermediate computational parameters of the wave function of the fermionic system to make one or more continuous nonlinear equations equal to zero, the one or more continuous nonlinear equations including at least one observable of the fermionic system that is determined, at least in part, by the quantum computer executing a quantum circuit;
adding to the Lagrangian, for each of the nonlinear equations, a product of the nonlinear equation times a Lagrange multiplier;
determining the Lagrange multipliers for each set of nonlinear equations to make the part of the Lagrangian corresponding these nonlinear equations stationary with respect to their respective intermediate computational parameters, the determination of the Lagrange multipliers depending on at least one observable that was determined, at least in part, by the quantum computer, the cost of determining the Lagrange multipliers depending on the number of intermediate computational parameters but not on the number of system parameters of the fermionic system with respect to which the first-order derivative are to be computed; and
obtaining at least one first-order derivative of an observable of the fermionic system with respect to any subset of system parameters by determining the partial derivatives of the Lagrangian with respect to these system parameters.

21. The non-transitory computer-readable storage medium according to claim 20, wherein the fermionic system further has orbitals, the orbitals being defined in terms of an orbital basis, the orbital basis depending in a differentiable way on one or more system parameters and on one or more orbital parameters, and the wave function of the fermionic system being defined with respect to a Hilbert space over these orbitals, and wherein the continuous intermediate computational parameters include the orbital parameters and wherein modifying the one or more continuous intermediate computational parameters of the wave function of the fermionic system comprises modifying one or more of the orbital parameters to make one or more nonlinear equations equal to zero, the one or more nonlinear equations including observable quantities of the fermionic system.

22. The non-transitory computer-readable storage medium according to claim 21, wherein the Hilbert space is the fermionic Fock space over the orbitals and is divided into a closed subspace, an active subspace, and a virtual subspace, whereby the subspaces are nonoverlapping spaces and the closed space and/or virtual space may be empty, and the wave function is restricted to be fully occupied inside the closed space and unoccupied in the virtual space.

23. The non-transitory computer-readable storage medium according to claim 20, the method further comprising:
choosing a mapping between the active space and a subspace of the Hilbert space of the quantum computer, whereby the subspace can be the full Hilbert space of the quantum computer;
determining values of one or more of the observable quantities with the assistance of a quantum computer performing quantum computations involving the preparation of one or more quantum states in the quantum computer corresponding to wave functions of the fermionic system under the chosen mapping by means of quantum circuits, the quantum circuits having one or more continuous circuit parameters;
modifying one or more circuit parameters to make one or more nonlinear equations involving the observable quantities equal to zero; and
adding to the Lagrangian, for each of the nonlinear equations, a product of the nonlinear equation times a Lagrange multiplier.

24. A data processing apparatus comprising a quantum computer configured to execute one or more quantum circuits, the quantum circuits depending on one or more continuous quantum circuit parameters, the data processing apparatus configured to perform a method for computing, given a fermionic system depending on one or more continuous system parameters and having a wave function and a set of one or more observables, a first-order derivative of one or more of the observables of the fermionic system, the method comprising:
defining a Lagrangian for each of the one or more observables to be differentiated as the formal definition of that observable;
defining a representation of the wave functions of the fermionic system depending on one or more continuous intermediate computational parameters, with at least one of these intermediate computational parameters being one of the continuous quantum circuit parameters;
modifying the one or more continuous intermediate computational parameters of the wave function of the fermionic system to make one or more continuous nonlinear equations equal to zero, the one or more continuous nonlinear equations including at least one observable of the fermionic system that is determined, at least in part, by the quantum computer executing a quantum circuit;
adding to the Lagrangian, for each of the nonlinear equations, a product of the nonlinear equation times a Lagrange multiplier;
determining the Lagrange multipliers for each set of nonlinear equations to make the part of the Lagrangian corresponding these nonlinear equations stationary with respect to their respective intermediate computational parameters, the determination of the Lagrange multipliers depending on at least one observable that was determined, at least in part, by the quantum computer, the cost of determining the Lagrange multipliers depending on the number of intermediate computational parameters but not on the number of system parameters of the fermionic system with respect to which the first-order derivative are to be computed; and
obtaining at least one first-order derivative of an observable of the fermionic system with respect to any subset of system parameters by determining the partial derivatives of the Lagrangian with respect to these system parameters.
